(19) United States
(12) Patent Application Publication
(10) Pub. No.: US 2012/0150512 A1
(43) Pub. Date: Jun. 14, 2012

(54) INFORMATION PROCESSING DEVICE FOR CALCULATING STRESS OF SUBSTANCE

(75) Inventor: Kentaro TAKAI, Kawasaki (JP)

(73) Assignee: FUJITSU LIMITED, Kawasaki (JP)

(21) Appl. No.: 13/399,567

(22) Filed: Feb. 17, 2012

Related U.S. Application Data
(63) Continuation of application No. PCT/JP2009/064470, filed on Aug. 18, 2009.

(51) Int. Cl. G06F 17/10

(52) U.S. Cl. 703/2

(57) ABSTRACT

An simulation device includes a first memory that stores an atomic structure containing atomic positions in a substance, a second memory that stores an atomic structure containing atomic positions in a crystal containing the atom, a dividing unit that compares the atomic positions of a plurality of divided portions into which the substance is divided with the atomic positions in the crystal, maps the atomic positions of the divided portions to the atomic positions of the crystal to specify the divided portions of the substance, a parallelepiped forming unit, a stress calculating unit that calculates a mean stress applied to the parallelepiped in a virtual crystalline structure in which the parallelepiped is iterated and a control unit that specifies the stresses of the respective divided portions of the substance by executing the system repeatedly.

### CROSS-REFERENCE TO RELATED APPLICATION

This is a continuation of Application PCT/JP2009/064470, filed on Aug. 18, 2009, now pending, the contents of which are herein wholly incorporated by reference.

### FIELD

The present invention relates to an information processing device for calculating stress of substance.

### BACKGROUND

On the occasion of developing a nanodevice, there has yearly increasingly been a tendency of using simulation based on a quantum theory. A reason why is that it is considered effective in developing a purpose-suited device to understand a physical phenomenon on a nanoscale to which not classical mechanics but quantum mechanics (quantum theory) is applied at the present time when further micronization of the nanodevices is accelerated. Occurrence of defects, flaws or cracks in the substance is given by way of one example of the physical phenomenon on the nanoscale. It is effective in understanding the occurrence of defects and cracks on the nanoscale to check, in greater detail, stability of an atomic structure of a microregion to which the quantum theory is applied. In any case, a calculation of a local stress is useful for understanding the occurrence of defects and cracks on the nanoscale or checking the stability of the atomic structure of the microregion.

As a calculation technique on the occasion of performing the simulation of the substance on the basis of the quantum theory, there exist a calculation technique using empirical parameters such as a tight-binding method and a calculation technique, e.g., a first-principle calculation (ab initio calculation) not using the empirical parameters.

The tight-binding (Tight-Binding) method defined as one of the calculation techniques based on the quantum theory using the empirical parameters is a calculation technique which follows.

Normally, in the tight-binding method, energy of a whole system is expressed as below.

$${E}_{tot} = {E}_{bs} + {E}_{rep} = 2 {\sum }_{n} {ɛ}_{n} + {E}_{rep} \qquad [ Mathematical Expression 1 ]$$

A first term of the right side represents energy based on interaction between an electron and an electron and energy based on interaction between an electron and an ion. Further, a second term represents the energy based on the interaction between the ion and the ion and correction of the first term. Still further, εn designates an eigenvalue of one-electron Hamiltonian. Namely, this is the eigenvalue of the Schrödinger equation of one electron.

H_{TB}φₙ(r)=εₙφₙ(r) [Mathematical Expression 2]

In the tight-binding method, for instance, a wave function as an eigenfunction of the Schrödinger equation of one electron is expressed by a sum of atomic orbitals as in the mathematical expression 3. The Schrödinger equation of one electron is a formula in which the Schrödinger equation is approximated by a technique called a mean field approximation. Accordingly, the Schrödinger equation of one electron does not give a meaning of the formula of treating a system of one electron.

$${ϕ}_{n} ( r ) = {\sum }_{l} {e}^{i k \cdot {R}_{l}} {\sum }_{i} {c}_{i} {φ}_{i} ( r - {τ}_{i} - {R}_{l} ) \qquad [ Mathematical Expression 3 ]$$

Herein, φi is an electronic orbital within the atom, n is a mode of the eigenvalue, R (bold face) is a translation vector, τ (bold face)ᵢ is a position of the atom, and k (bold face) is a wave number of the wave function. Further, R (bold face), τ (bold face)ᵢ and k (bold face) expressed by bold faces in the mathematical expressions are expressed simply by normal fonts such as R, τi and k in the specification.

Thus, the wave function is expanded with the atomic orbital, whereby a problem of solving the Schrödinger equation (differential equation) of one electron is replaced with a problem (eigenvalue problem) of finding a coefficient of the atomic orbital. To be specific, both sides of the Schrödinger equation are multiplied by Σ₁₀exp(−ikR₁₀)φj*(r−τj−R₁₀) from the left and integrated by the total space, thereby replacing the Schrödinger equation of one electron with the eigenvalue problem. Namely;

$$[ Mathematical Expression 4 ]$$

$$\int d r {\sum }_{{l}_{0}} {e}^{- i k \cdot {R}_{{l}_{0}}} {φ}_{j}^{*} ( r - {τ}_{j} - {R}_{{l}_{0}} ) {H}_{TB} {ϕ}_{n} ( r ) = {ɛ}_{n} \int d r {\sum }_{{l}_{0}} {e}^{- i k \cdot {R}_{{l}_{0}}} {φ}_{j}^{*} ( r - {τ}_{j} - {R}_{{l}_{0}} ) {ϕ}_{n} ( r ) {\sum }_{i} {c}_{i} {\sum }_{l , {l}_{0}} {e}^{i k \cdot ( {R}_{l} - {R}_{{l}_{0}} )} \int d r {φ}_{j}^{*} ( r - {τ}_{j} - {R}_{{l}_{0}} ) {H}_{TB} {φ}_{i} ( r - {τ}_{i} - {R}_{l} ) = {ɛ}_{n} {\sum }_{i} {c}_{i} {\sum }_{l , {l}_{0}} {e}^{i k \cdot ( {R}_{l} - {R}_{{l}_{0}} )} \int d r {φ}_{j}^{*} ( r - {τ}_{j} - {R}_{{l}_{0}} ) {φ}_{i} ( r - {τ}_{j} - {R}_{l} ) {\sum }_{i} {c}_{i} {\sum }_{l , {l}_{0}} {H}_{ij} ( {τ}_{i} , {τ}_{j} , {R}_{l} , {R}_{{l}_{0}} ) = {ɛ}_{n} {\sum }_{i} {c}_{i} {\sum }_{l , {l}_{0}} {S}_{ij} ( {τ}_{i} , {τ}_{j} , {R}_{l} , {R}_{{l}_{0}} )$$

Herein, Hij(τi, τj), Sij(τi, τj) are defined as follows.

Hᵢⱼ(τᵢ,τⱼ,Rₗ,Rₗ_{₀})=e^{ik·(R}^{ₗ}^{-R}^{ₗ₀}⁾∫drφⱼ*(r−τⱼ−Rₗ_{₀})H_{TB}φᵢ(r−τᵢ−Rₗ)

Sᵢⱼ(τᵢ,τⱼ,Rₗ,Rₗ_{₀})=e^{ik·(R}^{ₗ}^{-R}^{ₗ₀}⁾∫drφⱼ*(r−τⱼ−Rₗ_{₀})φᵢ(r−τᵢ−Rₗ) [Mathematical Expression 5]

In the tight-binding method, Hij(τi, τj), Sij(τi, τj) as functions of the distance are artificially determined so that the eigenvalues etc reproduce experimental values. At this time, the empirical parameters are used. Further, the tight-binding method has such a characteristic that a value given by (Number of Atoms of total System)×(Number of Valence Electrons per Atom) is sufficient for the number of coefficients cᵢ to be obtained, and hence a calculation load is light. For example, in order to perform the simulation by taking into consideration the electrons of the outermost shell of 100 silicon atoms, it follows that a 400-dimensional eigenvalue problem may be solved in the case of treating only the electrons of an s-orbital and a p-orbital.

On the other hand, there is the first-principle calculation based on a density functional theory as one of the calculation techniques based on the quantum theory not using the empirical parameters. The technique is as follows.

In the first-principle calculation, the energy of the total system can be expressed such as:

$$[ Mathematical Expression 6 ]$$

$$E = - \frac{1}{2} {\sum }_{i} \int d r {ϕ}_{i}^{*} ( r ) {∇}^{2} {ϕ}_{i} ( r ) + \frac{1}{2} \int d r d {r}^{′} \frac{n ( r ) n ( {r}^{′} )}{\vert r - {r}^{′} \vert} + {E}_{ec} [ n ( r ) ] + \int d {rv}_{ext} ( r ) n ( r ) + {E}_{ion}$$

The first term is kinetic energy of the electron, the second term is Coulomb energy between the electrons, the third term is an exchange-correlation term of the electrons, the fourth term is energy of the interaction between the electron and the ion, and the fifth term is energy of the interaction between the ions. Moreover, vₑₓₜ(r) represents a potential generated by the ions. Herein, φᵢ(r) and n(r) given above are a wave function and an electron density of one electron in a virtual system with no interaction between the electrons. φᵢ(r) and n(r) can be calculated by self-consistently solving an equation (Kohn Sham equation) of the mathematical expression 7 given below.

$$[ Mathematical Expression 7 ]$$

$$( - \frac{1}{2} {∇}^{2} + \int d {r}^{′} \frac{n ( {r}^{′} )}{\vert r - {r}^{′} \vert} + \frac{δ {E}_{xc} [ n ( r ) ]}{δ n ( r )} + {v}_{ext} ( r ) ) {ϕ}_{i} ( r ) = {ɛ}_{i} {ϕ}_{i} ( r )$$

$$n ( r ) = {\sum }_{i} {\vert {ϕ}_{i} ( r ) \vert}^{2}$$

A solution of the Kohn Sham equation involves widely using a method of expanding the wave function with a plane wave. A model of expanding the wave function with the plane wave is exemplified in the mathematical expression 8.

$${ϕ}_{i} ( r ) = {e}^{i k \cdot R} {\sum }_{G} {c}_{G} {e}^{i G \cdot r} \qquad [ Mathematical Expression 8 ]$$

Thus, with the expansion of the wave function with the plane wave, the problem of solving the Kohn Sham equation (differential equation) is replaced with the problem (eigenvalue problem) of finding the coefficient of the plane wave. When solving the eigenvalue problem, matrix elements are obtained without using the empirical parameters unlike the tight-binding method. Further, the first-principle calculation has such a characteristic that the number of the coefficients of the plane wave is extremely large. This is because the wave function locally residing in a site where the ions exist is to be expressed by superposition of the spreading plane wave. For example, the simulation of the silicon atoms containing two atoms entails solving the several-hundred dimensional eigenvalue problem. Accordingly, in the case of not using the empirical parameters, the number of atoms that can be treated decreases as compared with a case of using the empirical parameters as by the tight-binding method.

At the present, as a method of obtaining a mean value of the stresses in the crystal having a periodic structure, there exists a theory (Non-Patent document 1) which can be applied in common to both of these techniques. A specific method is given as follows.

(1) The energy of the crystal and the force acting on the atoms are obtained by solving Schrödinger equation, and the atomic structure is optimized, or alternatively a calculation of molecular dynamics is conducted.
(2) The mean value of the stresses is obtained by use of the atomic coordinates obtained by (1) and the wave function defined as the solution of the Schrödinger equation. The mean value of the stresses is expressed by a model of the mathematical expression 9 which follows.

$$[ Mathematical Expression 9 ]$$

$${T}_{α β} = - {\sum }_{i} 〈 Ψ \vert \frac{{\hat{p}}_{i α} {\hat{p}}_{i β}}{{m}_{i}} - {r}_{i β} {∇}_{i α} ( V ) \vert Ψ 〉$$

Herein, Tαβ is a stress, r represents atomic coordinates, Ψ is a wave function, mi is a mass of an atom i, an element of p hatted with (̂) is an operator of a momentum, and V is a potential. The symbol i is a label for identifying the atom, and Σ represents an addition with respect to the atoms contained in the system. Note that αβ implies any two elements of x, y, z. Hence, Tαβ is any one of Txx, Txy (=Tyx), Txz (=Tzx), Tyy, Tyz (=Tzy). For instance, Txy implies a y-directional stress acting on the plane (YZ plane) vertical to the x-axis.

Furthermore, in the calculation technique not using the empirical parameters, the calculation technique of the local stress is also developed (Non-Patent document 2). What is given as one example of the technique undergoing the development is a local stress calculation technique using the first-principle calculation based on the density functional theory. At first, the one-electron wave function and the electron density are obtained by solving the Kohn Sham equation defined as a primitive equation. The one-electron wave function and the electron density can be obtained as functions of three-dimensional coordinates, and hence, in the functional theory, the energy of the total system is given by a generic function of the one-electron wave function and the electron density. Accordingly, the stress defined as a differential quantity of the energy can be also obtained as a function of the three-dimensional coordinates, thereby enabling the local stress to be calculated.
[Patent document 1] Japanese Patent Application Laid-Open Publication No. 2003-347301
[Non-Patent document 1] O. H. Nielsen and R. M. Martin, Phys. Rev., U.S.A., B 32, 3780 (1985)
[Non-Patent document 2] A. Filippetti and V. Fiorentini, Phys. Rev., U.S.A., B 61, 8433 (2000)

### SUMMARY

One aspect of a technology of the disclosure can be exemplified as a simulation device. The simulation device includes: a first memory that stores an atomic structure containing atomic positions in a substance including an atom; a second memory that stores an atomic structure containing an atomic positions in a crystal containing the atom; a dividing unit that compares the atomic positions of a plurality of divided portions into which the substance is divided with the atomic positions in the crystal, maps the atomic positions of the divided portions to the atomic positions of the crystal to minimize an evaluation value of a relative distance between each atom of the divided portions and each atom of the crystal corresponding to each other and to specify the divided portions of the substance, corresponding to a unit lattice of the crystal; a parallelepiped forming unit that determines a parallelepiped to minimize an evaluation value of the relative distance between a vertex of the divided portion and a vertex of the parallelepiped; a mean stress calculating unit that calculates a mean stress applied to the parallelepiped in a virtual crystalline structure in which the parallelepiped is iterated; and a control unit that specifies stresses of the respective divided portions of the substance by controlling the dividing unit, the parallelepiped forming unit and the mean stress calculating unit repeatedly.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating one aspect of processing by an information processing device;

FIG. 2 is a diagram illustrating a procedure of simulation in the case of determining an atomic structure;

FIG. 3 is a processing example of obtaining microregions from the atomic structure of a substance.

FIG. 4 is a processing example of generating a parallelepiped from the microregions;

FIG. 5 is a processing example of interpolating a stress in an arbitrary position from the stress at a boundary surface between the microregions;

FIG. 6 is an example of an improper division;

FIG. 7 is an example of generating the microregions considered to be desirable;

FIG. 8 is a flowchart illustrating a process of dividing the atomic structure into the microregions;

FIG. 9 is a diagram illustrating crystalline structures of which a list is compiled for atomic types of a selected atom and atoms in the vicinity of the selected atom;

FIG. 10 is a diagram illustrating an example of calculating a root mean square (RMS) value of a distance between the atoms;

FIG. 11 is a diagram illustrating a procedure of determining the microregion to be divided;

FIG. 12 is a processing example in a case where two atoms exist within a primitive lattice of the crystal.

FIG. 13 is a processing example in the case where the two atoms exist within the primitive lattice of the crystal;

FIG. 14 is a processing example in the case where the two atoms exist within the primitive lattice of the crystal;

FIG. 15 is a format example of a database of the crystalline structures;

FIG. 16A is a diagram depicting the crystalline structure of a simple cubic lattice;

FIG. 16B is a diagram depicting an atomic structure of a real substance or an atomic structure in a virtual system obtained by simulation;

FIG. 17A is an example of the crystalline structure having a hexagonal close-packed structure;

FIG. 17B An example of the atomic structure in the virtual system obtained by the simulation;

FIG. 18A is a flowchart illustrating a process of transformation from the microregions into the parallelepiped;

FIG. 18B is a diagram illustrating the process of the transformation from the microregions into the parallelepiped by use of graphics;

FIG. 19 is a diagram illustrating a process of selecting three vertexes;

FIG. 20 is a flowchart illustrating a process of generating a parallelogram;

FIG. 21 is a diagram depicting how the atom is marked with a label;

FIG. 22 is a diagram illustrating an example of how the parallelogram is varied;

FIG. 23 is a diagram illustrating two types of parallelograms obtained when solving a conditional expression of the parallelogram;

FIG. 24 is a flowchart illustrating a process of generating the parallelepiped;

FIG. 25 is a diagram illustrating the parallelogram before being moved when forming the parallelepiped;

FIG. 26 is a diagram illustrating the parallelograms before and after being moved when forming the parallelepiped;

FIG. 27 is a diagram illustrating a condition imposed on a translational vector;

FIG. 28 is a diagram depicting a hardware configuration of the information processing device; and

FIG. 29 is a diagram illustrating a functional configuration of the information processing device.

### DESCRIPTION OF EMBODIMENT(S)

As already explained, for the simulation of the substance based on the quantum theory, there are the techniques using the empirical parameters and not using these parameters. At the present, the calculation of the mean value of the stresses can be performed by using any of these techniques. On the other hand, as for the calculation of a stress distribution, i.e., the local stresses, procedures of the technique not using the empirical parameters are developed. The technique not using the empirical parameters has, however, such a disadvantage that the number of the treatable atoms is on the order of several tens of atoms through several hundreds of atoms. Hence, an issue is a development of the method of calculating the local stress by the technique based on the quantum theory using the empirical parameters, which is, though its accuracy declines, capable of performing fast calculations.

By the way, in the case of the calculation technique not using the empirical parameters, as expressed in the mathematical expression 6, the energy is given as the function of the three-dimensional coordinates, and hence the stress can be also obtained as the function of the three-dimensional coordinates by differentiating the energy with the three-dimensional coordinates. In the case of the calculation technique using the empirical parameters, however, as expressed by the mathematical expression 1, the energy can not be expressed as the function of the three-dimensional coordinate, and therefore such a problem exists that the local stress can not be obtained by the differential operation as by the technique not using the empirical parameters.

If capable of calculating the local stress by the technique based on the quantum theory using the empirical parameters as represented by the tight-binding method, it is expected that the calculation of the local stress in the substance having a nanostructure containing a realistic number of atoms, e.g., several thousands of atoms or more, becomes attainable.

Under such circumstances, it is an aspect of a technology of the disclosure to provide a technology of calculating a stress distribution within a substance with respect to a result of simulation of atomic arrangement in the substance where an energy distribution in three-dimensional coordinates, which is acquired by a calculation technique using empirical parameters, is not obtained.

According to the technology of the disclosure, it is feasible to calculate the stress distribution within the substance with respect to the result of simulation of the atomic arrangement in the substance where the energy distribution in the three-dimensional coordinates, which is acquired by the calculation technique using the empirical parameters, is not obtained.

An information processing device according to an embodiment will hereinafter be described with reference to the drawings. A configuration in the following embodiment is an exemplification, and the information processing device is not limited to the configuration of the embodiment.

The information processing device is directed to a calculation technique of a local stress in a material design support application. Especially, the information processing device calculates the local stress based on a quantum theory which uses empirical parameters enabling a fast computation in a way that divides a target substance into microregions and assumes a virtual system having a periodic structure.

The technique using the empirical parameters is incapable of obtaining energy of the whole system with a functional of one electron wave function expressed in three-dimensional coordinates, and hence the same approach as the technique based on the quantum theory not using the empirical parameters can not obtain a stress, i.e., a differential quantity of the energy as the function of the three-dimensional coordinates.

Such being the case, the information processing device of the embodiment performs a simulation for seeking atomic coordinates of the substance, e.g., optimization of an atomic structure or a calculation of molecular dynamics, and thereafter divides the substance into the microregions by use of the calculated atomic coordinates and approximates the microregions of the divided substance with a parallelepiped. Then, the information processing device calculates a mean value of the stresses of the microregions by assuming the virtual system having the periodic structure with the parallelepiped serving as a unit lattice. Finally, the information processing device obtains a stress distribution by interpolating the stresses of the respective microregions.

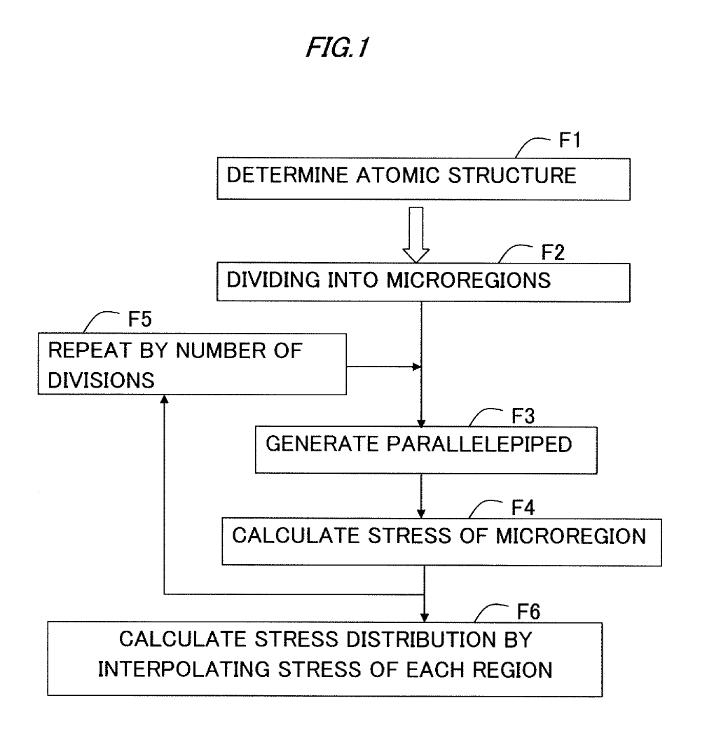

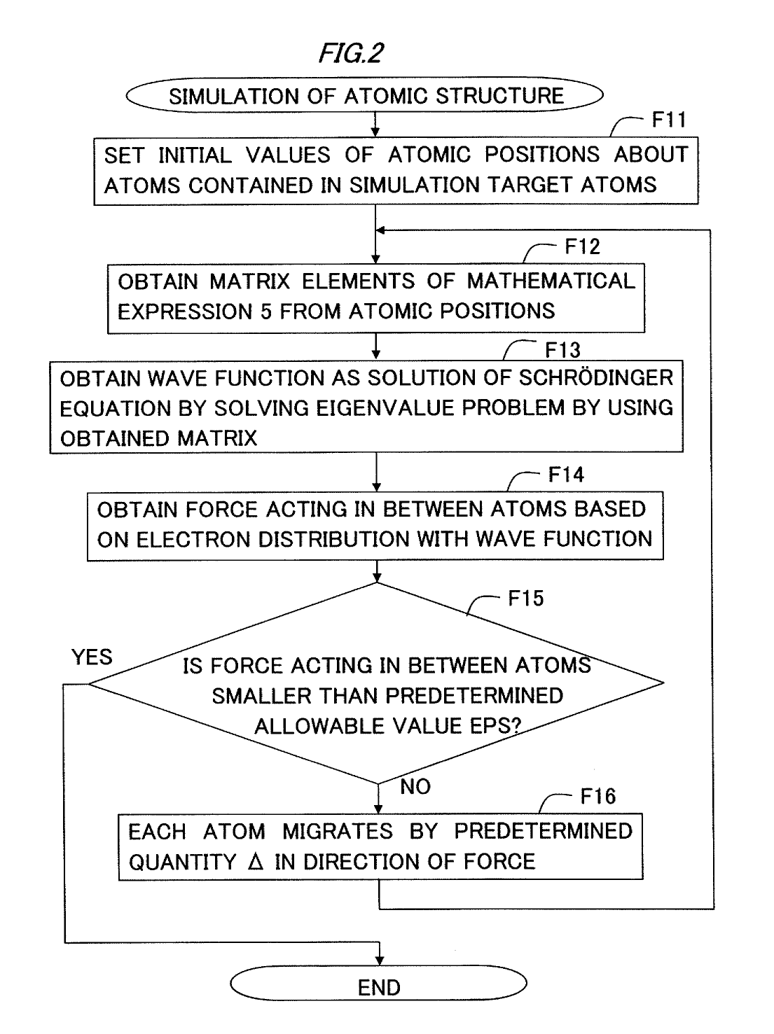

### First Working Example

<Processing Procedure> FIG. 1 illustrates one aspect of an outline of processes by the information processing device. The information processing device, at first, determines the atomic structure containing the atomic coordinates by the simulation which uses the empirical parameters (F1). FIG. 2 illustrates a simulation procedure in the case of determining the atomic structure. Explained herein is an outline of the simulation for seeking the atomic structure within the substance, i.e., the atomic coordinates thereof on the premise that the information processing device calculates the stress distribution. FIG. 2 is an example of a processing flowchart for obtaining the internal atomic structure of the substance. A CPU (Central Processing Unit) of the information processing device executes a computer program deployed in an executable manner on a memory and thus implements the simulation illustrated in FIG. 2. The processes for the CPU to execute the computer program will hereinafter be described simply as the processes of the information processing device.

In the processes of FIG. 2, to start with, the information processing device sets types of atoms and initial values of positions of the atoms contained in a simulation target substance in accordance with a user's designation (F11). The types of the atoms and the initial values of the positions of the atoms may be set in a parameter file on an external storage device such as a hard disk from which the information processing device performs reading. The parameters may also be set in a format such as (atomic types, X, Y, Z). Herein, X, Y, Z are values in the three-dimensional coordinates in which centers of the atoms are set.

Further, for example, a crystalline structure of an existing substance is displayed on, e.g., a display, and the user may also transform the crystalline structure through a manual operation. Herein, the “manual operation” connotes an operation of transforming the crystalline structure displayed on the display by a pointing device such as a mouse. For example, an available contrivance is that the crystalline structure displayed on the display can be dragged by a mouse cursor. Further, another available contrivance is that a menu for causing a breakage, a crack, etc in a part of the existing crystalline structure is provided, and the crystalline structure can be edited on the display in a manner that corresponds to a menu selection of the user. Moreover, still another available contrivance is to provide such a menu that the same type of atom as the atom in the crystal or a different type of atom can be inserted into the crystalline structure. It may be sufficient that the user can select the position where the atom is inserted and the type of the atom to be inserted. According to the process in F11 described above, the initial values of the positions of the atoms, which are desired by the user, are set by reading data from the parameter file or transforming the existing crystalline structure.

Next, matrix elements in the mathematical expression 5 are set based on the positions of the atoms and the atomic types of the atoms at the present by use of the empirical parameters (F12). For instance, a silicon atom is disposed in τi, and a hydrogen atom is disposed in τj, in which case the matrix elements are obtained by use of the empirical parameters so as to reproduce electronic properties of the silicon atom and the hydrogen atom, which are separated at a distance r given by r=|τi−τj|.

Next, the information processing device obtains ci by solving simultaneous equations in the mathematical expression 4 by employing the matrix elements Hij(τi, τj), Sij(τi, τj) obtained in F12. Then, the information processing device obtains a wave function defined as a solution of the Schrödinger equation in the same formula as the mathematical expression 3 by use of the thus-obtained ci (F13).

Subsequently, the information processing device obtains, based on the wave function acquired in F13, a force acting on between the atoms (F14). The force acting on between the atoms can be exemplified by, e.g., an electron binding force of an outermost shell of the atoms.

Next, the information processing device obtains a sum of the forces acting on between the respective atoms according to the force acting on between the atoms. Then, the information processing device determines, with respect to each atom, whether the sum of forces is smaller than a predetermined allowable value or not. The information processing device checks all of the simulation target atoms and determines whether the force acting on the atoms is smaller than a predetermined allowable value EPS or not (F15). Then, the information processing device, if the forces acting on all of the simulation target atoms are each smaller than the predetermined allowable value EPS, terminates the simulation.

Whereas if the force acting on any one of the simulation target atoms is equal to or larger than the predetermined allowable value EPS, the information processing device gets each atom to migrate by a predetermined quantity A in the direction of the force. Note that the migrating direction of the atom corresponds to the direction of the force acting on each atom, while the predetermined migration quantity A of the atom may be a common value shared among the simulation target atoms. Further, the predetermined migration quantity A of the atom may also be a value corresponding to the force acting on the atom. Then, the information processing device returns control to F2 and obtains again a potential ambient to the atom.

Then, the information processing device repeats the processes in F12 through F16 till the force acting on the atom becomes smaller than the predetermined allowable value EPS. In the procedure such as this, the information processing device obtains the atomic structure stable with respect to the initial values of the positions of the atoms, which are set in F11. The technique of obtaining the stable position of the atom as in FIG. 2 is called optimization of the atomic structure, and involves using generally a method of steepest descent and a conjugate gradient method. The atomic structure obtained hereat is a structure in which internal energy at absolute zero is minimized. Further, a process of obtaining the atomic structure at a given temperature and under a given pressure is executed by a computer system to which an algorithm called a molecular dynamics calculation is applied.

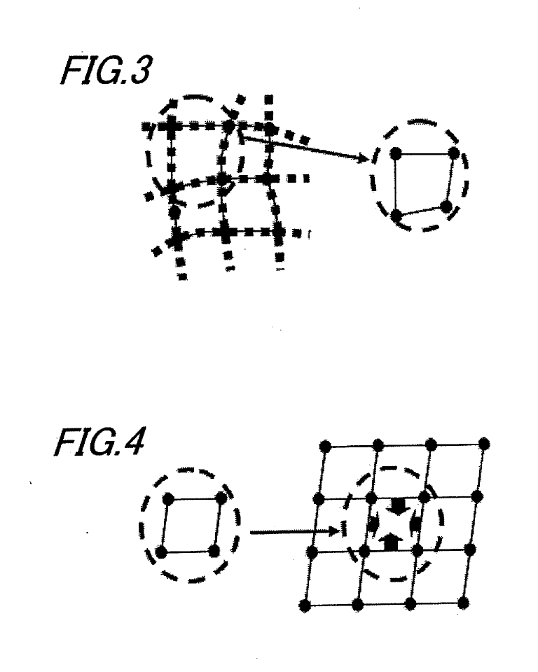

Next, referring back again to FIG. 1, the discussion will be made. After determining the atomic structure in the processes as in FIG. 2, a 3-stage procedure from F2 onward is conducted in order to obtain the local stress by use of the atomic coordinates in the determined atomic structure. To begin with, the information processing device divides the substance of which the atomic structure is determined into the microregions (F2). The information processing device determines a shape of the divided micro-region on the basis of the unit lattice when the atoms are assembled to form the crystals. The phrase “determine on the basis of” implies, e.g., a process of comparing the known unit lattice when the atoms are assembled to form the crystals with the atomic structure obtained in F1 and extracting an assembly of atoms having a minimum deviation quantity from the known unit lattice. FIG. 3 is a processing example of obtaining the micro-region from the atomic structure of the substance. In the example of FIG. 3, the assembly of atoms contained in a portion circumscribed by a circle is extracted as the micro-region.

Subsequently, the information processing device calculates the stress acting on the divided microregions. The information processing device approximates the divided microregions to the parallelepiped and sets the virtual system in which the divided microregions are periodically arranged. With respect to a calculation technique of the mean value of the stresses within the crystals having a periodic structure, there is established a theory common to both of the technique using the empirical parameters and the technique not using these parameters. Such being the case, the information processing device executes the quantum calculations, based on the established theory by setting the virtual system in which the divided microregions are periodically arranged, thereby enabling the mean value of the stresses in the virtual system to be obtained.

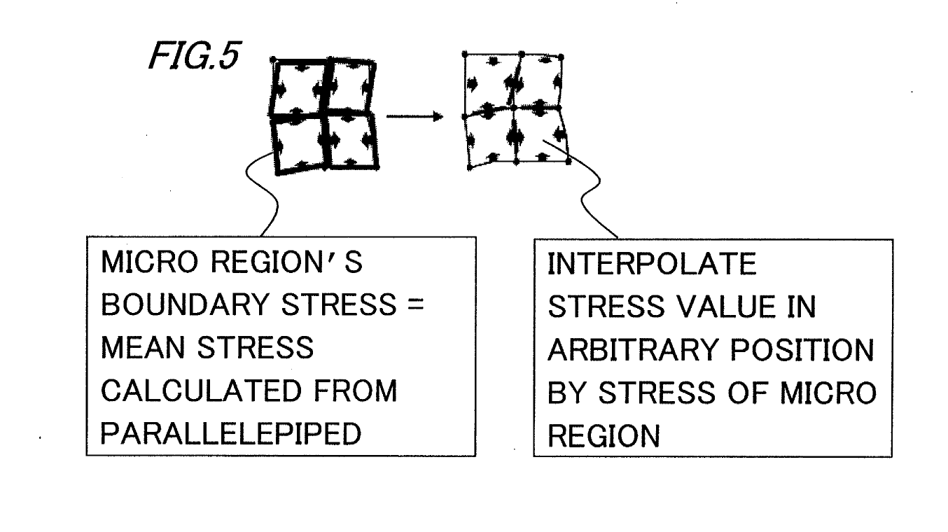

Thus, for calculating the stress acting on the microregions, the information processing device generates the parallelepiped from the microregions obtained in F2 (F3). FIG. 4 is a processing example of generating the parallelepiped from the microregions. The information processing device replaces the micro-region extracted from the atomic structure in the process of F2 with the parallelepiped having a bottom surface formed in parallelogram and a predetermined translation vector. FIG. 4 depicts a plan view of the parallelepiped as viewed in one axial direction.

Then, the information processing device calculates the stresses acting on the parallelepiped (F4). In the calculation of the stresses, the information processing device assumes such a three-dimensional structure that the parallelepiped obtained in F3 is infinitely iterated. Then, the information processing device obtains the mean value of the stresses acting on the single parallelepiped in the iterative structure of the regular parallelepiped. Subsequently, the information processing device determines the obtained mean value of the stresses as the stress of the microregions. Then, the information processing device repeats the processes in F3 and F4 by the number of the microregions (F5).

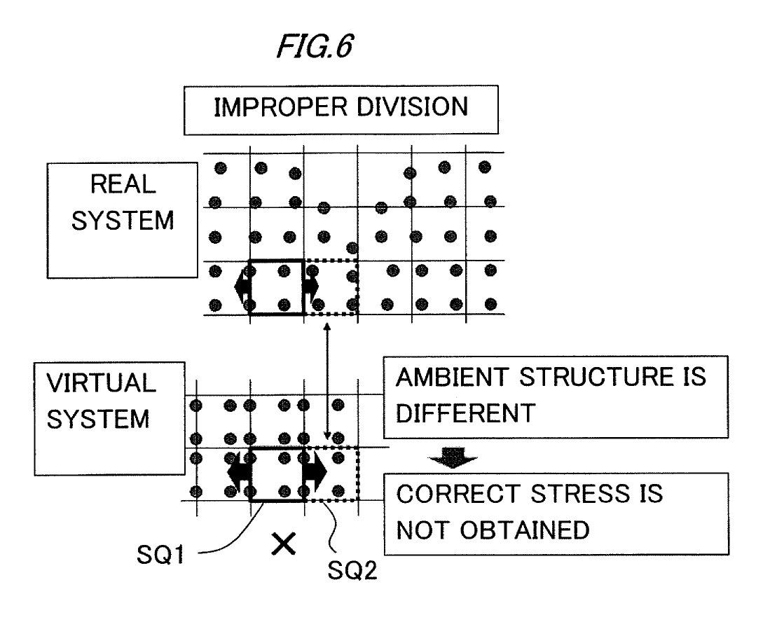

The stress per microregion in the substance is obtained in the processes of F3-F5. The stress per micro-region can be said to be the stress on a boundary surface of the micro-region (see FIG. 5). Next, the information processing device obtains the stress distribution by interpolating the stresses other than those on the boundary surfaces of the microregions on the basis of the stress per micro-region (F6). FIG. 5 illustrates a processing example of interpolating the stresses in arbitrary positions from the stresses on the boundary surfaces of the microregions. Through the processes described above, the information processing device obtains the stress distribution of the substance acquired in the process of F1.

<Division of Atomic Structure into Microregions>

Herein, an in-depth description of the process of F2 in FIG. 1 will be made. The following is a description of a method of how the substance having a nanoscale, i.e., the substance not perfectly formed with the crystalline structure into the microregions. If simply divided in a grid pattern, there is a possibility that the atomic structure affecting the calculation of the stress might differ between a real system and the virtual system in which the microregions are periodically arranged.

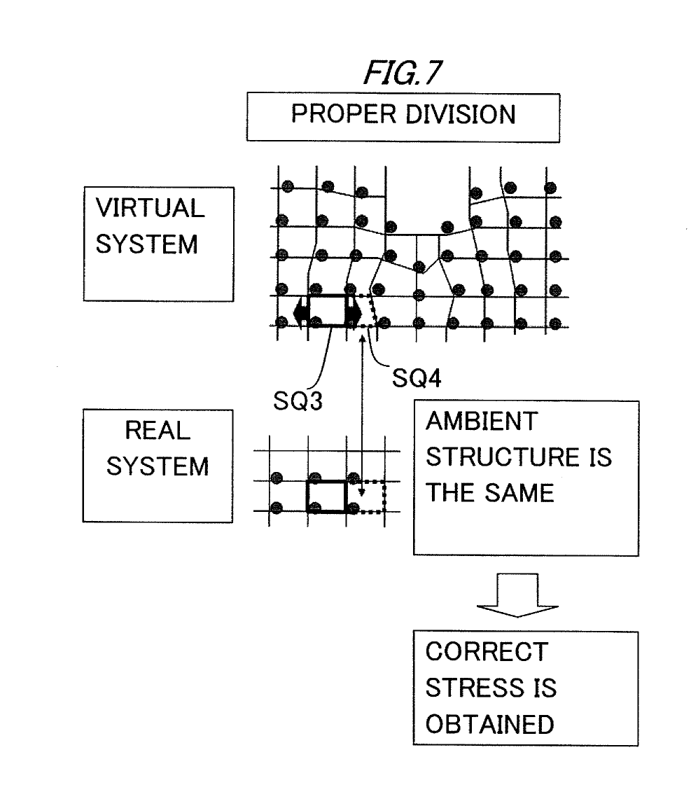

FIG. 6 illustrates an example of improper divisions. The real system in FIG. 6 illustrates the atomic structure of the actual substance. Further, the virtual system in FIG. 6 represents the atomic structure determined by the simulation as in FIG. 2. As in FIG. 6, there might exist some portions that are not necessarily coincident between atomic structure in the real system and the atomic structure in the virtual system determined by the simulation.

What is now considered is a case of the division into the microregions designated by SQ1 and SQ2 by way of the division into the microregions in the virtual system. Herein, both of the microregions SQ1 and SQ2 are the microregions obtained by cutting the atomic structure of the virtual system in a fixed mesh.

In the case of forming the parallelepiped explained in FIG. 1 with respect to the microregions SQ1 and SQ2 and taking the procedure of obtaining the average of the stresses, a relationship between the atomic structure contained in SQ1 and the atomic structure ambient to SQ1 is not coincident with the real system. Further, with respect to the microregions Q2 also, the relationship between the atomic structure contained in SQ2 and the atomic structure ambient to SQ2 is not coincident with the real system. Accordingly, with respect to the microregions SQ1, SQ2, even when respectively simply forming the parallelepiped and calculating the mean stress, there is a high possibility of not matching with the stress which occurs on the real substance.

This being the case, the atomic structure in the virtual system obtained by the simulation is divided into the microregions, in which case it is considered desirable that the microregions are generated in the way of being mapped to the atomic structure in the real substance to the greatest possible degree. For example, even if the real substance contains a distortion of the crystalline structure, a defect of the lattice, a transition, a grain boundary, contamination of impurity atoms, etc and if the atomic structure deviates from an intrinsic positional relationship between the atoms of the substance, it is desirable that the microregions are generated in the way of being mapped to the atomic structure in the real substance to the greatest possible degree. This is because the generation of the microregions mapped to the atomic structure in the real substance, even if the atomic structure in the virtual system does not coincide with the real system, increases a possibility that the calculation result of the stress distribution in the virtual system becomes similar to the stress distribution in the real system.

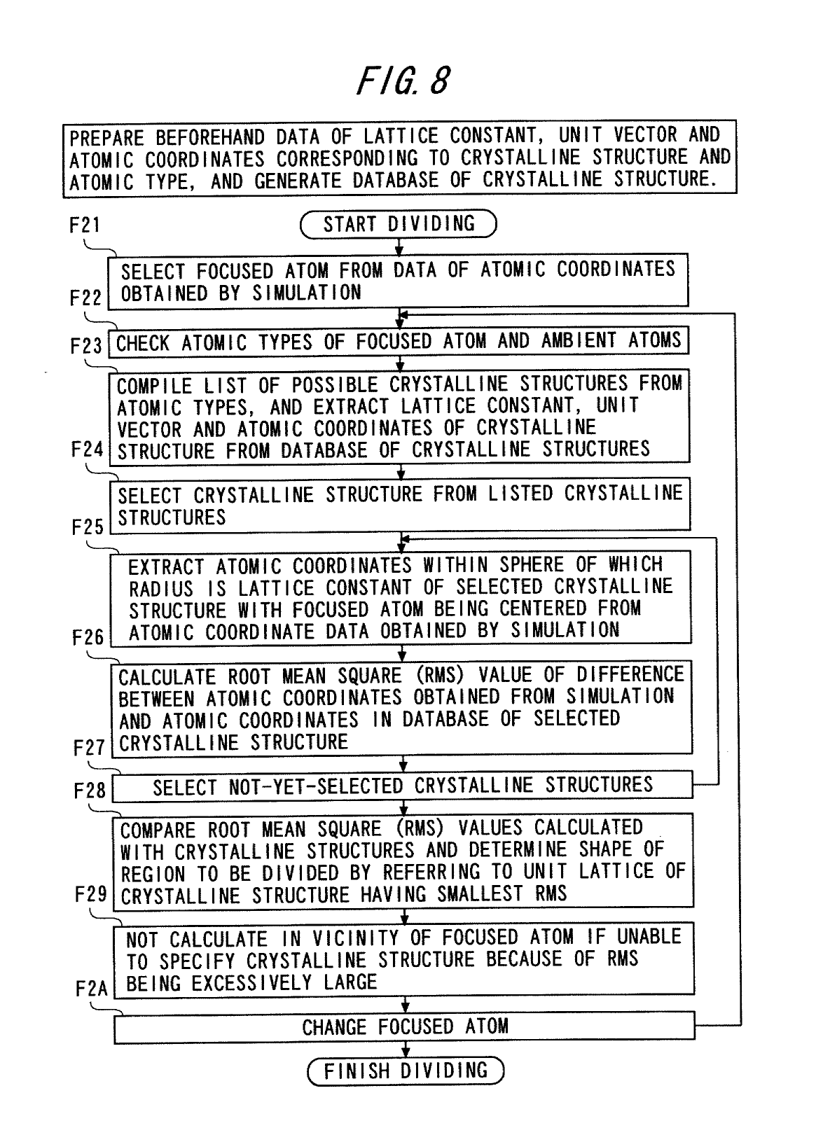

FIG. 7 depicts an example of generating the microregions that are considered desirable. The example of FIG. 7 includes a portion (microregion) SQ3 approximate to the regular atomic structure in reality and a portion (microregion) SQ4 in which a distance between the atoms is compressed adjacently to SQ3. For the atomic structure such as this, the information processing device generates the microregions in preference to a relationship corresponding to the intrinsic positional relationship between the atoms contained in a primitive lattice of the atomic structure as in SQ3, SQ4 in place of the divisions into the fixed regions as in FIG. 6. Therefore, the crystalline structure known about the atomic type of the substance is utilized as a reference model of the atomic structure of the real substance.

Namely, the information processing device does not perform the division into the fixed regions but compares, e.g., a relationship between the unit lattice or the primitive lattice in the real crystal lattices and the atomic structure of the virtual system, then extracts an atomic assembly corresponding (mapped) to the unit lattice or the primitive lattice in the real crystal lattices, and sets this atomic assembly as the microregion. Accordingly, even in a distorted state of the atomic structure in the virtual system, the information processing device detects a portion in which the atomic structure corresponding to the unit lattice or the primitive lattice in the real crystal lattices is in the distorted state, and sets this portion as the microregion.

Herein, the “unit lattice” connotes the lattice having, normally, the shortest length in side in the iterative structure of the crystal. The unit lattice is called a unit cell. Further, for representing the symmetry intrinsic to the crystal more explicitly, the iterative structure built up by the assembly of the plurality of unit lattices is defined as a unit of iteration as the case may be. Including what the plural unit lattices are assembled, the iterative structure of the crystal is also called the primitive lattice or a primitive cell. The following discussion on the first working example involves using the terminology “unit lattice” which embraces the meanings of both of the unit lattice and the primitive lattice.

The information processing device extracts, as illustrated in FIG. 7, the atomic structure corresponding to the unit lattice or the primitive lattice in the real crystal lattices from within the atomic structures of the simulated virtual system. In the atomic structure corresponding to the unit lattice such as this, the relationship between the focused microregion and the atomic structure ambient to the microregion is similar to the relationship between the unit lattice of the real crystal lattices and the ambient atomic structure. Accordingly, even when individually extracting the microregions, replacing the extracted microregions with the parallelepipeds, making a regular arrangement of the parallelepipeds and obtaining the mean value of the stresses from this arrangement, the relationship between the microregion and the atomic structure ambient to the microregion can become approximate to that of the real substance.

Such being the case, the information processing device, at first, specifies one or more crystalline structures when the focused atom and the ambient atoms form the crystal from the atomic type of the focused atom and from the atomic types of the atoms ambient to the focused atom. Then, the information processing device determines the shape of the microregion on the basis of the primitive lattice of the specified crystalline structure, and divides the substance into the microregions. A reason why the unit lattice is used is that the unit lattice is suited to the periodic arrangement of the microregions in the process of F3 in FIG. 1.

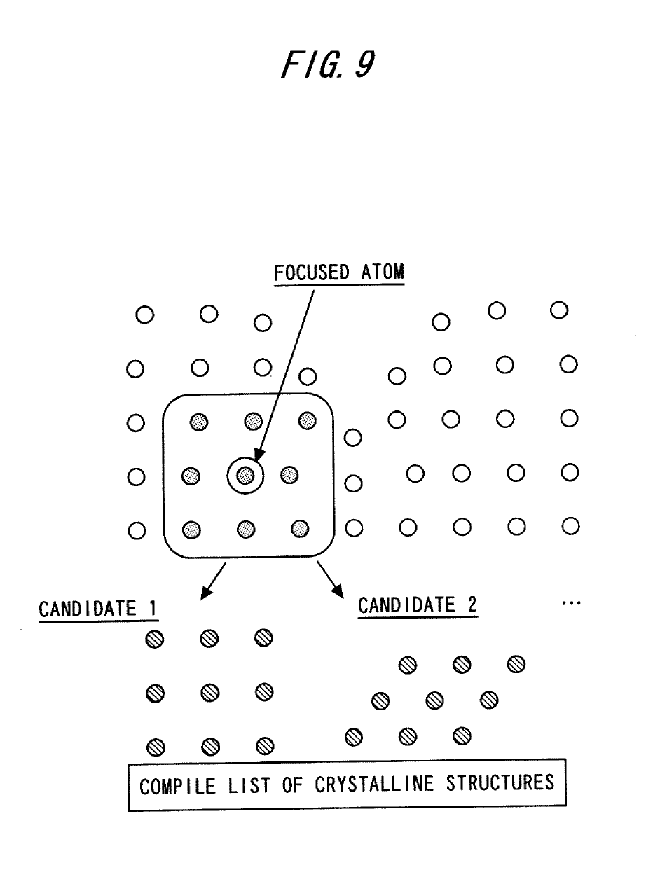

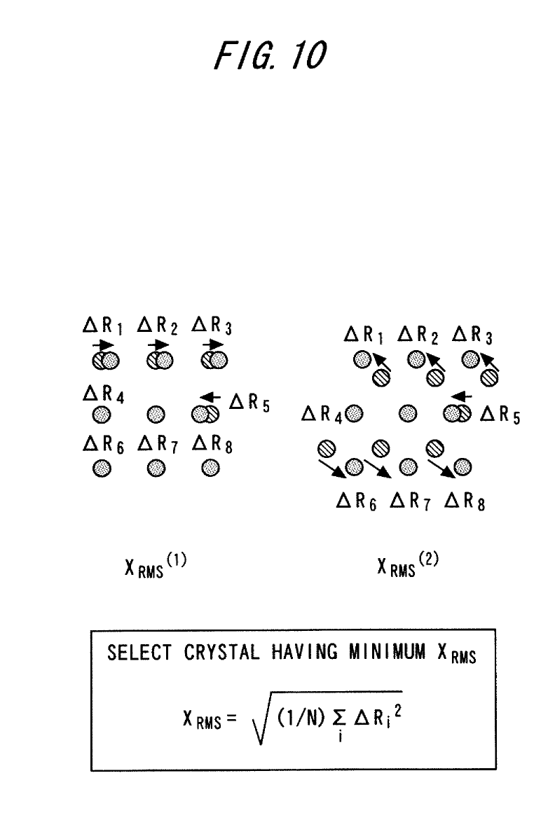

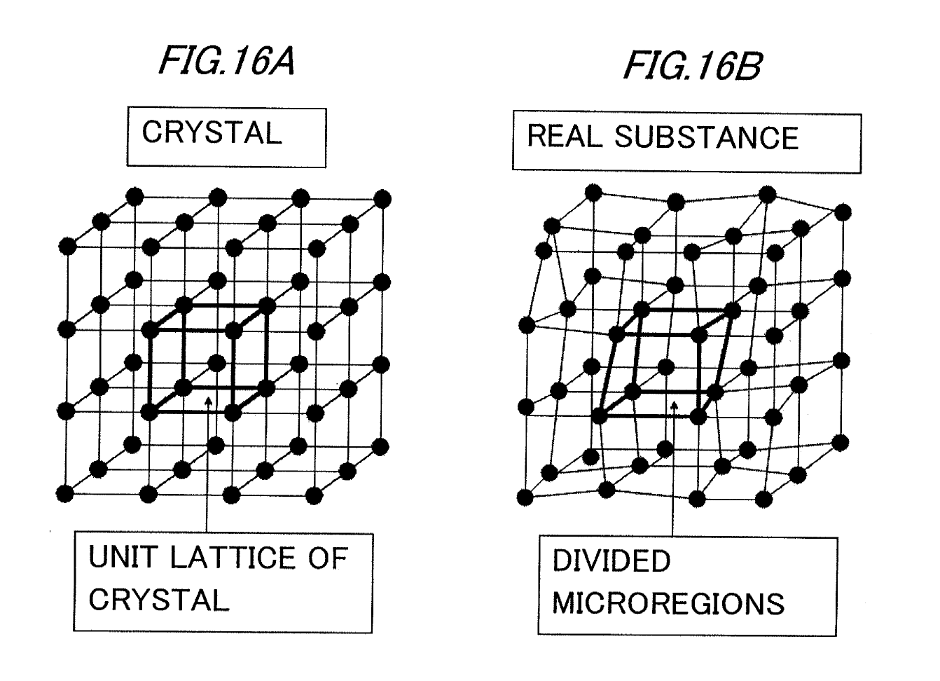

FIGS. 8 through 14 illustrate a tangible procedure of dividing the virtual system into the microregions. FIG. 8 is a flowchart illustrating the processing procedure of dividing the virtual system into the microregions. FIGS. 9 through 14 are examples of how the dividing process of the atomic structure into the microregions is done by the information processing device. Processes illustrated in FIGS. 8-14 are also the processes in which the CPU of the information processing device executes the computer program deployed in the executable manner on the memory. Further, FIG. 15 illustrates a database format of the crystalline structure, which is retained by the information processing device.

The information processing device, for dividing the atomic structure of the substance into the microregions, prepares beforehand items of data of a lattice constant, a unit vector and atomic coordinates corresponding to the crystalline structure and the atomic type, and stores the data in the database of the crystalline structure. For instance, in the example of FIG. 15, the silicon atom is exemplified as the atomic type. Then, the number of crystalline structures, which can be taken by the silicon atom, i.e., the atomic type, is defined such as “crystalline structure count=2”.

Then, two crystalline structures are defined corresponding to the “taken-by-the-atomic-type crystalline structure count=2”. The lattice constant, the unit vector of the crystalline structure and the atomic coordinates are defined by way of the respective crystalline structures. Herein, the lattice constant is a length of the lattice. For instance, in the case of a cubic lattice, the lattice constant is single. On the other hand, in the lattices other than the cubic lattice, generally three lattice constants are defined. For example, these lattice constants are a lattice constant a in a first axial direction, a lattice constant b in a second axial direction and a lattice constant c in a third axial direction. Herein, the first, second and third axial directions connote the directions of the crystal lattices, respectively.

It is noted that when a hexahedron is supposed to exist in the crystal of the substance, there can be substances in which the atoms do not exist in all of positions of eight vertexes of the hexahedron. If capable of defining the hexahedron in which the atoms exist at the five vertexes among the eight vertexes of the hexahedron, however, the positions of the vertexes at which the atoms do not exist can be specified from the atomic coordinates of the five vertexes. Then, the information processing device estimates, with respect to such a substance that the atoms do not exist at some of the vertexes of the hexahedron, the positions of the vertexes with no existence of the atoms from the vertexes of the hexahedron, at which the atoms exist.

Further, e.g., even when defining the unit lattice of such a crystalline structure that the atoms exist at the center of the hexahedron, the vertexes of the hexahedron can be estimated based on the lattice constants, a, b and c. For example, the vertex can be specified as a position obtained by adding or subtracting a/2, b/2, c/2 to or from a position (0, 0, 0) of the atom. Hence, the vertexes of the hexahedron of the crystalline structure can be determined from the positions of the atoms by keeping a functional relation between the coordinates of the atoms and the vertex coordinates of the hexahedron.

Moreover, the “unit vectors” connote unit vectors of the three axes of the crystal lattice. In FIG. 15, e.g., the unit vectors are represented by the three unit vectors such as (a1x, a1y, a1z), (a2x, a2y, a2z), (a3x, a3y, a3z).

Further, the atomic coordinates connote the coordinates representing the position of the atom in the crystal. Note that an origin of the atomic coordinates is set to a predetermined position within the crystal, e.g., the center of the crystal, one vertex of the crystal lattice, and so on. The database of the crystalline structure contains the atomic coordinates, and this is because the atomic coordinates do not necessarily exist at the vertexes of the lattice even if capable of generating the crystal lattice by use of the unit vectors and the lattice constants.

Next, a process of dividing the atomic structure into the microregions will be described with reference to FIG. 8. At first, the information processing device selects one atomic coordinate from the data of the atomic coordinates obtained by the simulation (F21).

Then, the information processing device checks the atomic types of the selected atom and the atoms in the vicinity of the selected atom (F22). Herein, the “vicinity” may embrace, e.g., the selected atom and the atoms disposed in the positions adjacent to the selected atom in the atomic structure. Then, the information processing device compile a list of the crystalline structures that can be taken from the database of the crystalline structures by the selected atom and the atomic types of the atoms in the vicinity of the selected atom when forming the crystal. Then, the information processing device extracts the lattice constant, the unit vector and the atomic coordinates of each crystalline structure from the database of the crystalline structures (F23).

For example, if all of the atomic types of the focused atom and the vicinal atoms are of the silicon atoms, the crystalline structure of the silicon atom is a diamond structure or a β tin structure. Further, the diamond structure and the β tin structure are each defined as the crystalline structure of the silicon atom by the format of FIG. 15 in the database of the crystalline structures. Then, the information processing device extracts, e.g., the two lattice constants, the unit vector and the atomic coordinates with respect to the silicon atom from the database of the crystalline structures.

FIG. 9 illustrates the crystalline structures of which the list is compiled with respect to the atomic types of the atom selected in F21 and the vicinal atoms. Note that the atom selected in F21 is treated as a focused atom in FIG. 9.

Next, the information processing device selects one crystalline structure from within some listed crystalline structures (F24). Then, the information processing device extracts the atomic coordinates within the sphere having a radius that is twice the lattice constant, with the atom selected in F21 being centered, from the atomic coordinate data of the substance, which are obtained by the simulation (F25).

Calculated then is a root mean square (RMS) value of a difference between the atomic coordinates given from the simulation and the atomic coordinates in the atomic structure existing in the database of the crystalline structures (F26). If there are a plural number of atomic coordinates within the sphere of which the radius is twice the lattice constant, a minimum value is selected as the root mean square (RMS) value of the difference between the atomic coordinates of the atomic structure. The root mean square (RMS) value of the difference between the atomic coordinates given from the simulation and the atomic coordinates in the atomic structure existing in the database of the crystalline structures is an example of an evaluation value of a relative distance. For instance, such a case is assumed that there are atomic coordinates T1-Tk other than the atomic coordinates selected in F21 within the sphere having the radius that is twice the lattice constant.

To start with, the information processing device makes the position of the atom selected in F21 coincident with the position of any one of the atoms within the crystal lattice. Then, the information processing device extracts, from within the crystal, atomic positions (e.g., from P1 to Pk) other than the position within the crystal where the atom selected in F21 is positioned. Then, the information processing device calculates, based on the following formula, the root mean square (RMS) value of the inter-atom distance between the atomic coordinates T1 through Tk obtained from the simulation and the atomic positions P1-Pk within the crystal.

RMS=((1/N)×ΣDi×Di)^{1/2}; where Di is a distance between the atoms in a mapped atom pair i, Σ is a sum of “i=1” through k, and k is the number of RMS calculation target atoms.

As already described, the atoms do not necessarily exist at the lattice points of the lattice depending on the atomic type or the crystal structure. As depicted in FIG. 15, however, the database of the crystalline structures retains the atomic coordinates on a per crystalline structure basis of the atomic type, and the information processing device can, if the list of the crystalline structures can be compiled, specify the atomic positions in the crystalline structure of the atomic type concerned.

Then, such a mapping relation between the atomic positions is obtained as to minimize the root mean square (RMS) value of the inter-atom distance between the atomic coordinates T1 through Tk in the substance that are obtained from the simulation and the atomic coordinates P1 through Pk in the crystal. Subsequently, the information processing device retains the minimum value of the root mean square (RMS) value of the inter-atom distance.

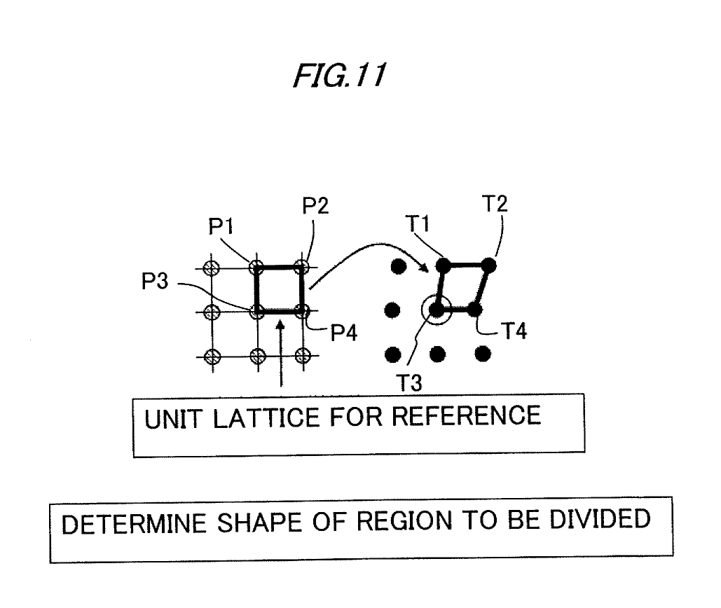

FIG. 10 depicts an example of how the root mean square (RMS) value of the inter-atom distance is calculated. In FIG. 10, the position of the focused atom selected in F21 is set to the position of the atom at the center of the crystalline structure. Then, eight distances Ri (i=1 to 8) are calculated between each of the atoms ambient to the central atom in the crystal and each of the atoms ambient to the central atom in the substance.

The information processing device repeats a series of procedures F22-F26, i.e., the selection of the crystalline structure, the extraction of the data from the atomic coordinates obtained by the simulation and the calculation of RMS with respect to all of the listed crystalline structures (F27).

Then, the information processing device makes comparisons among RMSs calculated with the respective crystalline structures, and determines the unit lattice of the crystalline structure having the smallest RMS. Subsequently, the information processing device determines the shape of the region to be divided on the basis of the unit lattice of the crystalline structure having the smallest RMS (F28). Namely, the information processing device obtains the atomic coordinates given from the simulation, which correspond to the atoms in the unit lattice of the crystalline structure having the smallest RMS. Obtained then is the microregion configured by the atomic coordinates acquired from the simulation, which correspond to the atoms in the unit lattice of the crystalline structure having the smallest RMS.

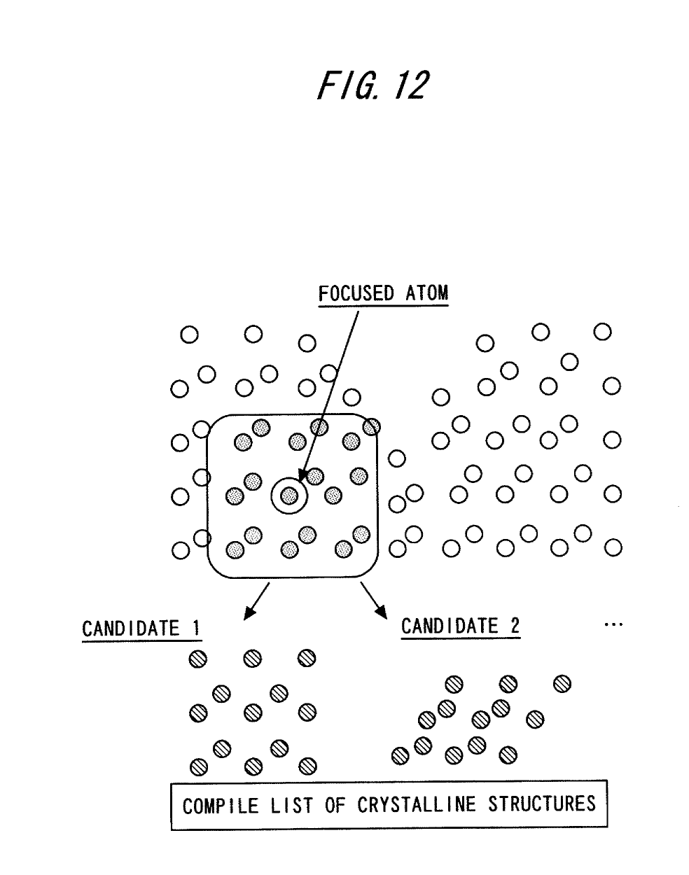

FIG. 11 illustrates a procedure of determining the microregion to be divided. For example, in FIG. 11, in mapping between the atomic positions P1-P4 in the crystal and the atomic coordinates T1-T4 in the substance that are obtained from the simulation, if the root mean square (RMS) value of the difference in distance between the atoms is minimized, the information processing device sets the region acquired by the atomic coordinates T1-T4 as the microregion.

It is noted that, as already stated, if none of the atoms exist at some of the plural vertexes, the positions of the vertexes with no existence of the atoms are estimated from the vertexes at which the atoms exist. For example, if the atoms do not exist at the three vertexes in the eight vertexes, such a hexahedron may be generated as to minimize the RMS with respect to the five vertexes at which the atoms exist. Further, if the atomic coordinates are provided in the positions other than the eight vertexes of the unit lattice in the crystal, there is at first obtained such a mapping relation as to minimize the RMS of the differential value of the coordinates between the atoms in the crystalline structure and the atoms in the substance undergoing the simulation. Obtained subsequently is the functional relation between the coordinates for specifying the positions of the hexahedron acquired from the lattice constant with respect to the atomic coordinates in the crystal. Then, the microregions of the substance may be obtained by applying the functional relation between the coordinates to the simulated atomic coordinates of the substance, which are mapped to the atomic coordinates in the crystal. In any case, according to the information processing device, the microregion takes the shape of the hexahedron.

Note that if the minimum RMS becomes larger than a predetermined limit value, the stress in the vicinity of the focused atom is not calculated (F29). Herein, the “predetermined limit value” may be set in the memory as a parameter of the information processing device as in the case of a value as the lattice constant multiplied by a predetermined integer N. The information processing device divides the region by performing the operations in F22-F29 for the atomic coordinates obtained by the simulation (F2A).

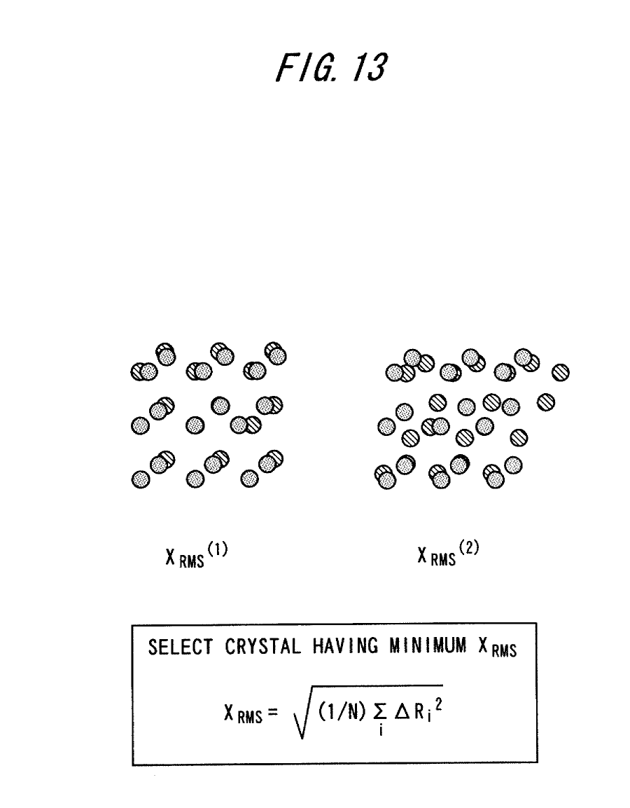

FIGS. 12-14 illustrate processing examples of being divided based on other crystal lattices. FIGS. 12-14 are the processing examples in a case where the two atoms exist within the primitive lattice of the crystal. FIG. 12 depicts the atom selected in F21, the atomic types of the atoms vicinal to the selected atom and an example of the listed crystalline structures.

As in FIG. 12, the information processing device compiles the list of the crystalline structures by searching through the database of the crystalline structures on the basis of the atom selected in F21 and the atomic types of the atoms in the vicinity of the selected atom.

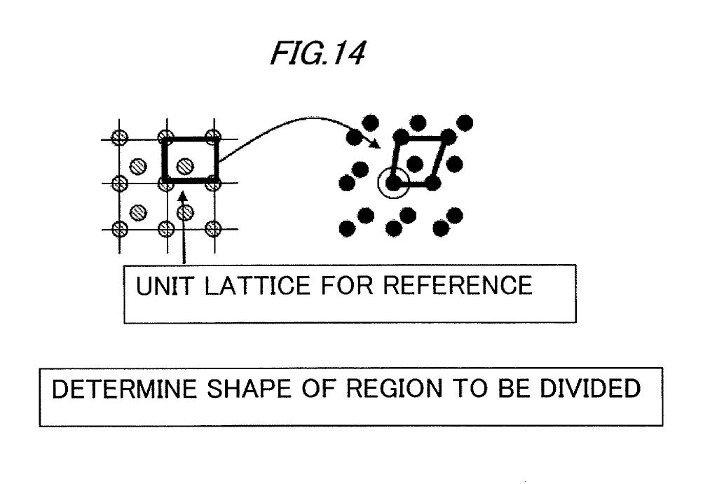

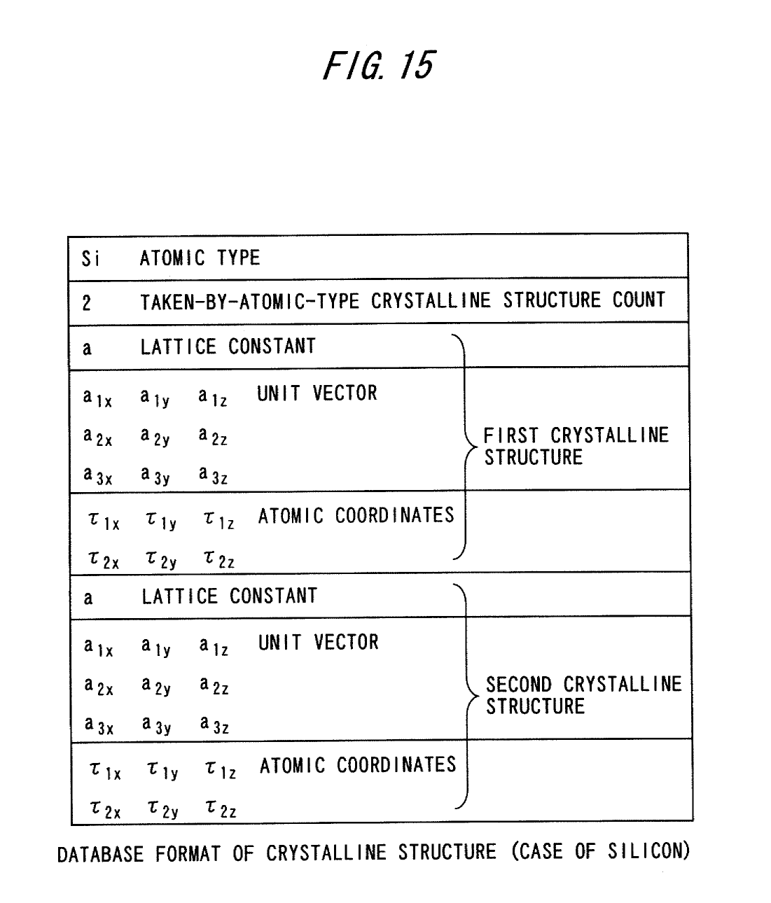

Then, as in FIG. 13, there is obtained a case of minimizing the root mean square (RMS) value of the difference in distance between the atoms by mapping the atomic coordinates given from the simulation to the atomic positions in the crystal. Subsequently, as in FIG. 14, the atomic coordinates given from the simulation that correspond to the atoms in the primitive lattice of the crystal are acquired based on such a mapping relation as to minimize the root mean square (RMS) value of the difference in distance between the atoms in the respective crystalline structures.

Note that Bravais lattices are given as what characterizes a translation symmetry of the crystal. Totally, fourteen types of Bravais lattices exist. Specifically, the fourteen types of Bravais lattices are simple triclinic, simple monoclinic, base-centered monoclinic, simple orthorhombic, body-centered orthorhombic, face-centered orthorhombic, base-centered orthorhombic, simple hexagonal, simple rhombohedral, simple tetragonal, body-centered tetragonal, simple cubic, body-centered cubic and face-centered cubic.

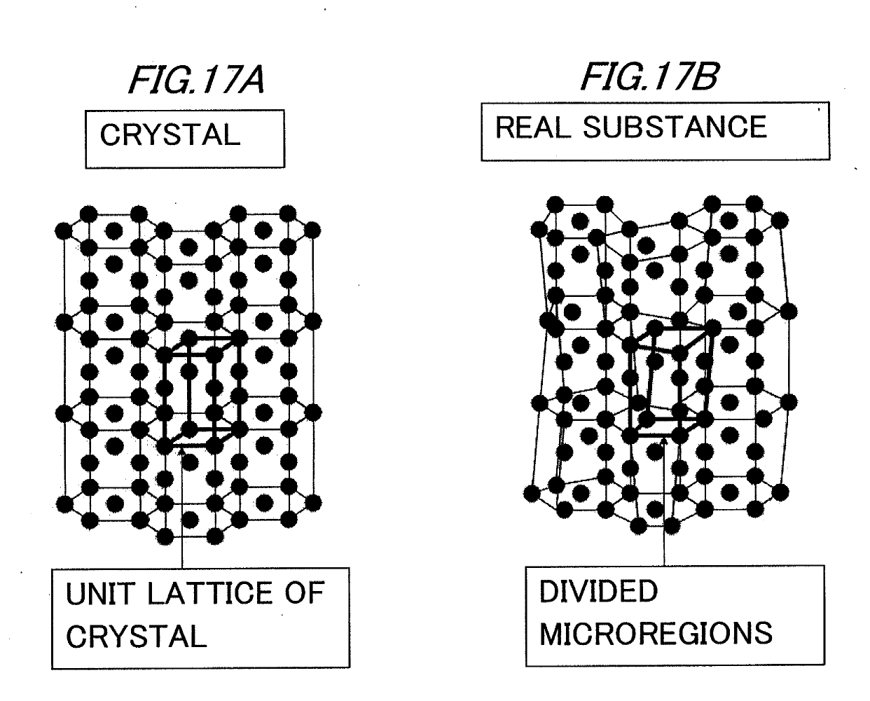

For instance, when the atomic type of the focused atom has the Bravais simple cubic lattice and takes the crystalline structure such as a simple cubic structure and if the RMS is minimized, the information processing device divides the region so that the microregions takes a shape approximate to a cube. FIG. 16A depicts the crystalline structure of the simple cubic lattice. FIG. 16A illustrates the crystalline structure that can be said to be an ideal crystalline structure. Further, FIG. 16B illustrates the atomic structure of the real substance or the atomic structure of the virtual system that is obtained by the simulation, with respect to the same atomic type as that in FIG. 16A. As in FIG. 16B, the atomic structure of the real substance or the atomic structure of the virtual system that is obtained by the simulation, takes a distorted structure deviating from the ideal crystalline structure in many cases. Accordingly, even if the atomic structure of the real substance or the atomic structure of the virtual system that is obtained by the simulation is divided into the microregions of which dimensions and a shape are fixed, the microregion mapped to the crystalline structure peculiar to the atomic type can not be acquired. On the other hand, it is feasible to acquire a state in which the crystalline structure intrinsic to the atomic type is distorted in a way that seeks such a case as to minimize the root mean square (RMS) value of the difference in inter-atom distance between the atoms within the crystalline structure and the atomic structure of the real substance or the atoms in the atomic structure of the virtual system obtained by the simulation in accordance with the procedure illustrated in FIG. 8.

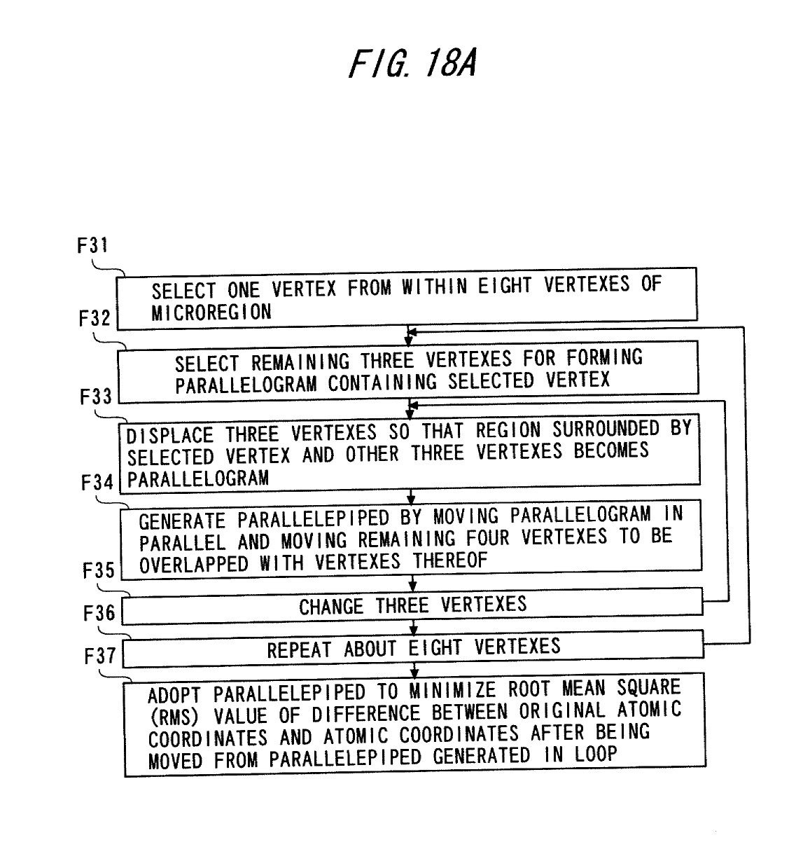

FIG. 17A is an example of the crystalline structure having a hexagonal close-packed structure. As in FIG. 17, the coordinates of the atoms are disposed at the atoms positioned at the vertexes of a hexagonal column and the center of the edge surfaces of the hexagonal column. Furthermore, when forming two rectangles and two triangles that are configured by line segments connecting the four vertexes taking a shape of the rectangle among the vertexes of the hexagon of the edge surface to the center of the hexagon, there are formed two square columns each having the rectangular edge surfaces and two triangular column each having the triangular edge surfaces. In these columns, the atoms are disposed also at the central portion of the square column. Further, a square column is configured by combining the triangular column with the triangular column contained in the adjacent hexagonal column, and the atoms are disposed also at the central portion of the thus-configured square column. Also in the crystalline structure having the hexagonal close-packed structure such as this, the hexahedron can be defined in a position indicated by an arrow linked with characters “UNIT LATTICE OF CRYSTAL” in FIG. 17A.

Moreover, FIG. 17B is an example of the atomic structure of the virtual system that is obtained by the simulation for estimating the atomic structure of the real substance with respect to the same atomic type as the crystal in FIG. 17A. If the RMS is minimized between the atoms of the crystalline structure, i.e., the hexagonal close-packed structure containing the Bravais simple hexagonal lattice and the atoms of the atomic structure of the virtual system, the information processing device makes the division into the microregions each taking a shape approximate to the square column having a rhomboidal bottom surface. A division size may be set substantially equivalent to a volume of the unit lattice in the crystal.

<Transformation of Microregions into Parallelepiped>

As described in F3 and F4 of FIG. 1, the periodic arrangement of the divided microregions entails transforming the regions into the parallelepiped. The reason therefore is that preparing the periodic structure built up by a translational operation of the microregions is usable in order to calculate the stress of the microregion, and that a polyhedron which enables a three-dimensional space to be filled by the translational operation is the parallelepiped. Moreover, the periodic structure is prepared for applying the calculation technique based on the generally known quantum theory. The information processing device performs the translation so as to minimize the root mean square (RMS) value of the displacement from the original atomic arrangement in order to minimize a change in local stress due to the transformation.

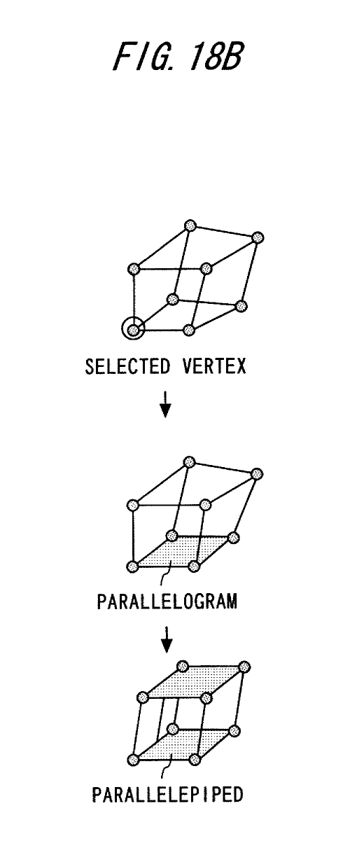

FIG. 18A is a flowchart illustrating a process of the transformation into the parallelepiped from the microregions. Further, FIG. 18B illustrates a process of the transformation into the parallelepiped from the microregions by use of graphics. The processes in FIGS. 18A and 18B are also the processes carried out in such a way that the CPU of the information processing device executes the computer program deployed in the executable manner on the memory.

To begin with, the information processing device selects one vertex from within the eight vertexes of the microregions extracted in the process in F2 of FIG. 1 (F31). FIG. 18B illustrates a position of the selected vertex.

Next, the information processing device selects the remaining three vertexes used for generating the parallelogram containing the vertex selected in F31 (F32). The hexahedron is presumed as the microregions transformed into the parallelepiped, and hence the process in F32 becomes a process of selecting other three vertexes that form the quadrangle together with the vertexes selected in F31.

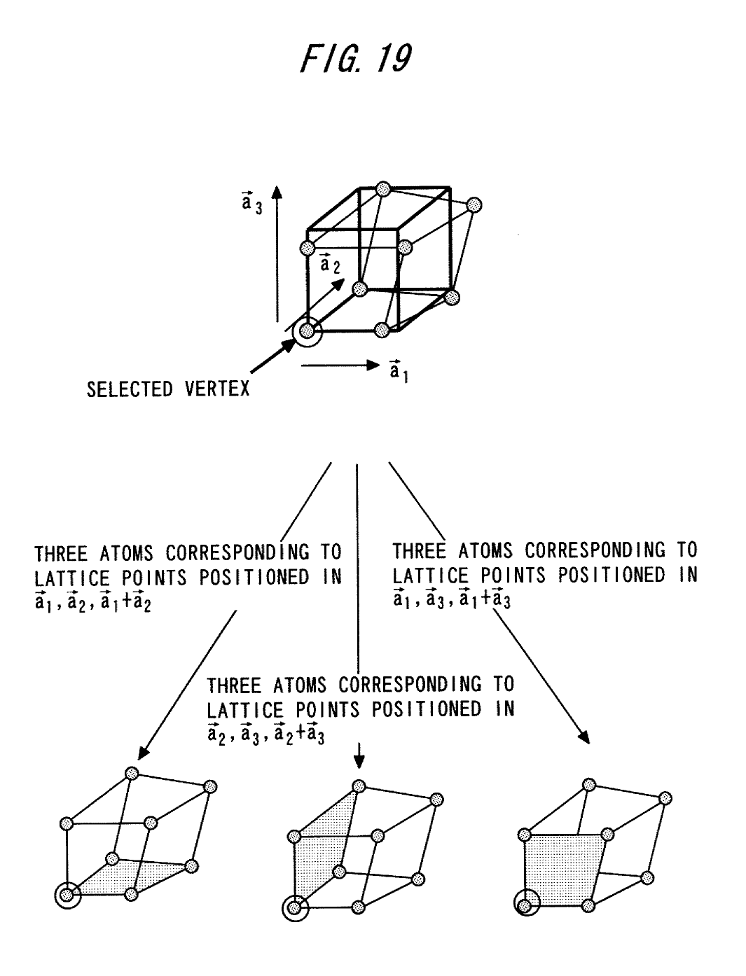

FIG. 19 illustrates a process of selecting the three vertexes. The selection of the three vertexes from the seven vertexes involves using the unit vector (a1->, a2->, a3->) of the space lattice. Note that the vector a1 is expressed such as “a1->” in the sentences of the specification.

For instance, when the atom selected in F31 is set as the origin, the following three ways are given.

(1) The three atoms corresponding to the lattice points positioned in a1->, a2->, a1->+a2->;
(2) The three atoms corresponding to the lattice points positioned in a2->, a3->, a2->+a3->; and
(3) The three atoms corresponding to the lattice points positioned in a3->, a1->, a3->+a1->
The parallelogram is generated with respect to the three patterns given above.

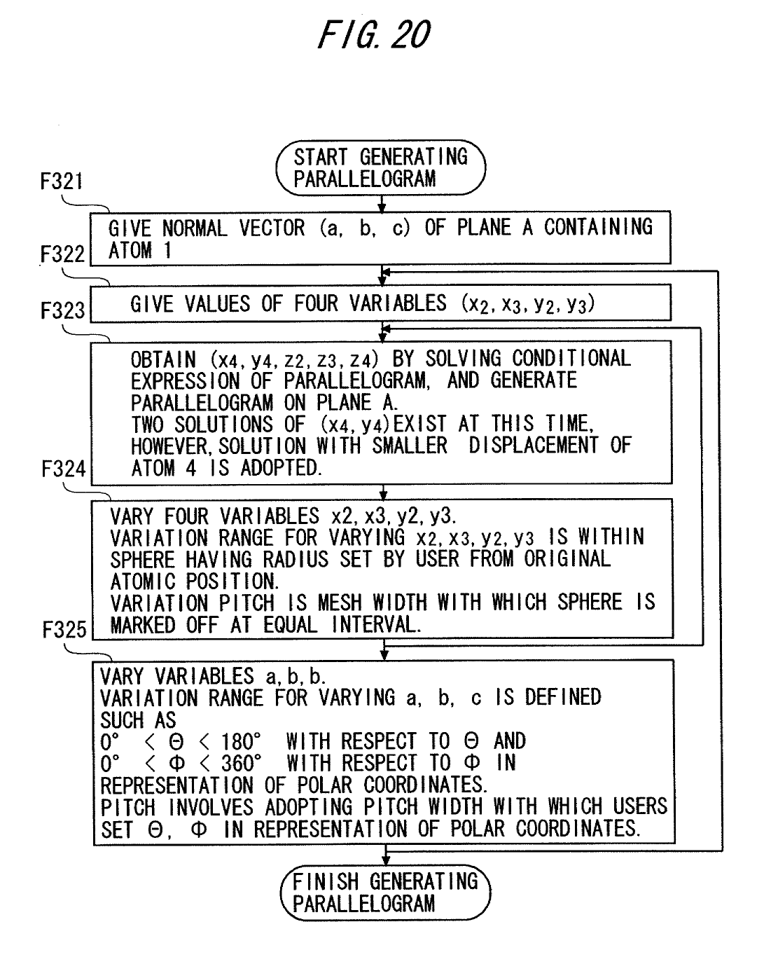

Then, the information processing device displaces other three vertexes so that the regions surrounded by the selected vertex and other three vertexes form the parallelogram (F33). In the process in F33, the parallelogram has arbitrary lengths of the sides, and there is no limit to angles made by the planes of the parallelogram. The process in F33 will be described in greater detail in FIGS. 20-23.

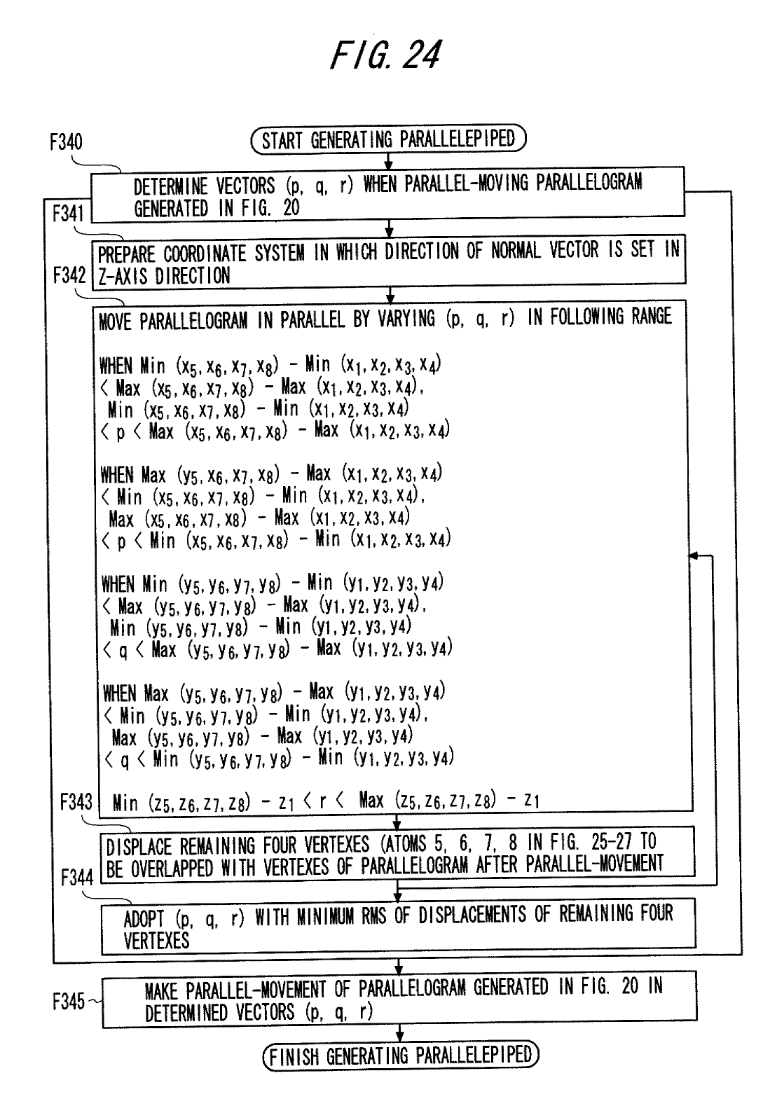

Next, the information processing device generates the parallelepiped. The information processing device executes the process conforming with a definition of the parallelepiped such as “the parallelepiped is surrounded by six planes, the two face-to-face planes are the parallelograms that are congruent and parallel, and the remaining four planes are the parallelograms”. Namely, the information processing device generates a candidate for the parallelepiped configured by moving the parallelograms generated in F33 in parallel. Herein, there are moved the remaining four vertexes in the microregions other than the four vertexes selected in the process in F32 and moved so as to form the parallelogram in F33. That is, the information processing device displaces the remaining four vertexes so that the candidate vertexes of the parallelepiped are overlapped with the vertexes of the microregions, and thus generates the parallelepiped (F34). A further in-depth description of the process in F34 will be made in FIG. 24.

The information processing device changes the three vertexes excluding the vertexes selected in F31 and repeats the process in F33 (F35). Moreover, the information processing device changes the vertexes to be selected and executes the operations in F32-F35, which are performed for the eight vertexes existing in the region (F36).

Then, the information processing device calculates the RMS of the displacement of the moved seven vertexes, i.e., the moved atoms, and employs the parallelepiped having the smallest RMS as the unit lattice of the virtual system (F37). In the procedure described above, the multiple parallelepipeds are generated, however, it is possible to obtain the parallelepiped under the condition “such a parallelepiped as to minimize the RMS of the displacement of the moved atoms is to be selected”.

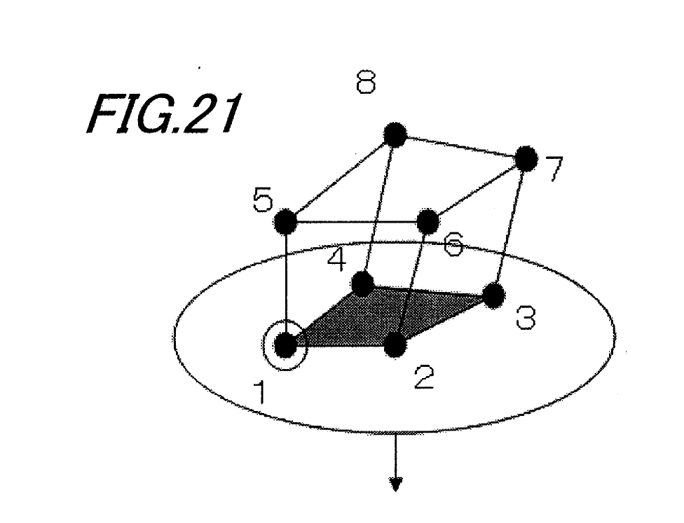

FIG. 20 illustrates the process in F33 of FIG. 18A, i.e., the parallelogram generating process. Described hereinafter is a procedure of how the information processing device displaces the three vertexes other than the vertexes selected in F31 so that the region surrounded by the vertexes selected in the process in F31 or F36 and other three vertexes forms the parallelogram. Herein, labels are attached to the atoms as in FIG. 21.

A condition that the four atoms exist on the same plane is satisfied for generating the parallelogram of which the vertexes are the selected atom (atom 1) and other three vertexes (atoms 2, 3, 4). Such being the case, an arbitrary place containing the atom 1 and having the normal vectors (a, b, c) is considered, and the atoms 2, 3, 4 are displaced on the plane. An equation satisfying this plane is given as below.

a(x−x1)+b(y−y1)+c(z−z1)=0 (Formula 1)

where (x1, y1, z1) are coordinates of the atom 1.

Let the prepared plane be a surface A, then the atoms 2, 3, 4 are displaced on the surface A, and hence the following formula is established.

a(x2−x1)+b(y2−y1)+c(z2−z1)=0 (Formula 2)

a(x3−x1)+b(y3−y1)+c(z3−z1)=0 (Formula 3)

a(x4−x1)+b(y4−y1)+c(z4−z1)=0 (Formula 4)

where (xi, yi, zi) are coordinates of the atom i.

The quadrangle with the atoms 1, 2, 3, 4 serving as the vertexes is to be the parallelogram, and therefore the formulae 5 and 6 are established from the condition that the lengths of the opposite sides are equal.

(x2)−x1)²+(y2−y1)²+(z2−z1)²=(x3−x4)²+(y3−y4)²+(z3−z4)² (Formula 5)

(x4−x1)²+(y4−y1)²+(z4−z1)²=(x3−x2)²+(y3−y2)²+(z3−z2)² (Formula 6)

From the formulae (2)-(6), when giving the arbitrary normal vectors (a, b, c) and if giving the four values among indeterminate coefficients, x2, x3, x4, y2, y3, y4, z2, z3, z4, it is feasible to generate the parallelogram of which the vertexes are the atomic coordinates of the atoms, 1, 2, 3, 4 on the plane A. Note that since the atom 1 does not undergo the transformation, the coordinates (x1, y1, z1) are used as they are and therefore the known coordinates.

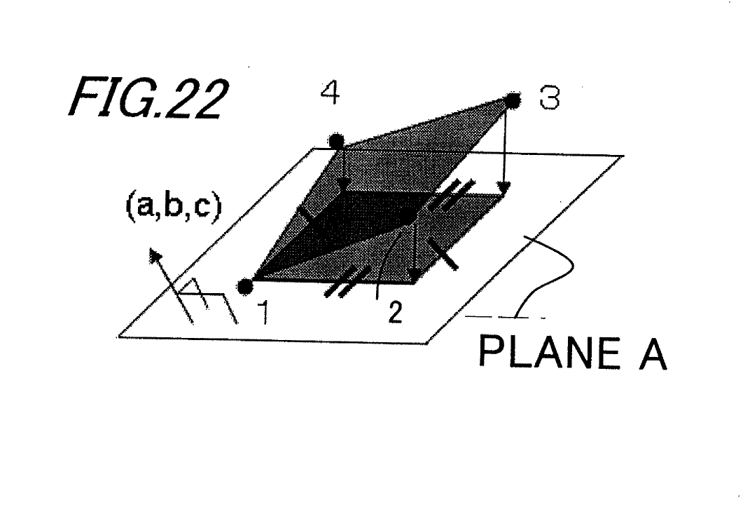

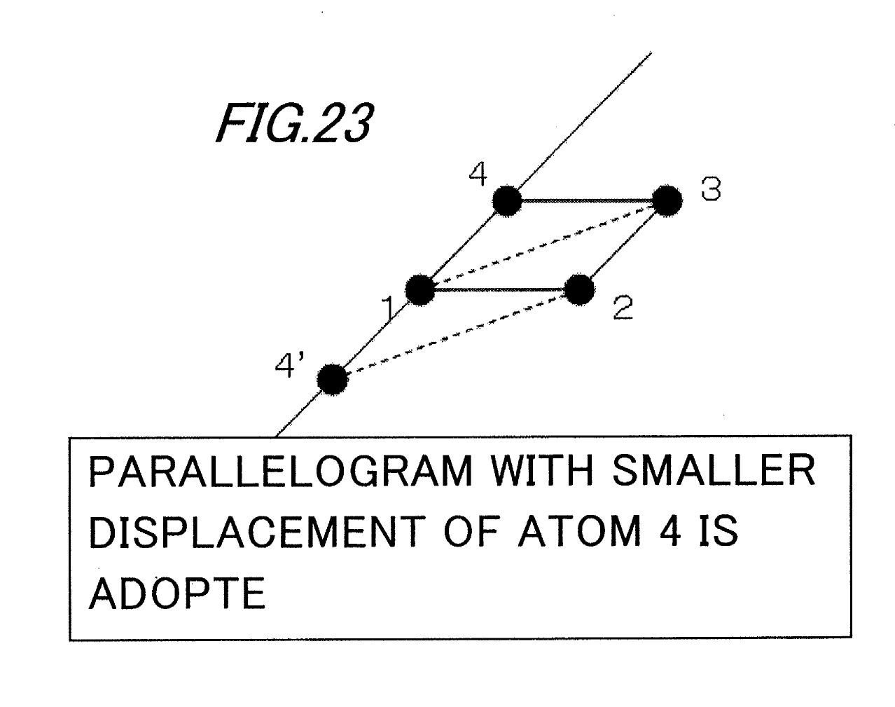

For example, there exist, however, two types of parallelograms generated when giving the four variables and the values of x2, x3, y2, y3. Namely, two solutions are given when solving the formulae 5 and 6, and hence the information processing device adopts the smaller of the (two) displacements of the atom 4. FIG. 22 and FIG. 23 illustrate the two types of parallelograms obtained when solving the formulae 5 and 6.

The operation described above is performed in a way that varies the values of the normal vectors and the four variables x2, x3, y2, y3, thereby preparing a variety of parallelograms. The procedure of varying the variables x2, x3, y2, y3 is exemplified as follows. At first, a variation range of x2, x3, y2, y3 is to be within a sphere having a radius set by a user from the original atomic position. A variation pitch is to be a mesh width with which the sphere is marked off at equal intervals. Further, a means for varying the normal vectors (a, b, c) is that the variation range is defined such as 0°<θ<180° with respect to θ and 0°<φ<360° with respect to φ in the representation of polar coordinates. The pitch width is to be a pitch width with which the user sets θ, φ in the representation of polar coordinates. There are prepared the parallelograms when varying x2, x3, y2, y3, a, b, c at the variation pitch described above within the range described above. FIG. 22 illustrates the example of the varied parallelograms.

FIG. 20 is a flowchart illustrating a process of how the information processing device generates the parallelogram. The information processing device gives the initial values of the normal vectors (a, b, c) on the plane A containing the atom 1 (F321). The initial values may be set such as (θ, φ)=(Δθ, Δφ) in the polar coordinates. Herein, Δθ, Δφ are pitches when varying θ and φ. Further, the normal vectors on the plane containing the central coordinates of the atoms 1, 2, and 3 are also available.

Next, the information processing device gives the initial values of the four variables (x2, x3, y2, y3) (F322). The initial values of the four variables (x2, x3, y2, y3) may be, e.g., edge points of the meshes marked off at the equal intervals within the sphere having the radius set by the user.

Subsequently, the information processing device obtains (x4, x4, z2, z3, z4) by solving the formulae 2-6, and thus generates the parallelograms on the plane A. At this time, two solutions of (X4, Y4) are given. Then, as discussed above, the smaller of the (two) displacements from the atom 4 is selected (F323)

Next, the information processing device varies the four variables (x2, x3, y2, y3) by the pitch width of the predetermined variation (F324). Then, the information processing device returns the control to F323. Thus, the information processing device executes the process in F323 within the sphere having the radius set by the user from the original atomic position.

Subsequently, the information processing device varies the normal vectors (a, b, c) on the plane (F325). Then, the information processing device returns the control to F322. In this way, the information processing device varies the normal vectors within the range such as 0°<θ<180° with respect to θ and 0°<φ<360° with respect to φ in the representation of polar coordinates, and repeatedly executes the processes in F322-F325.

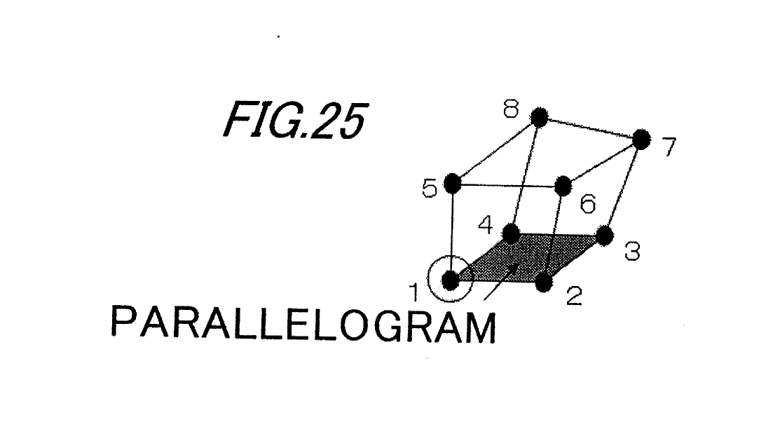

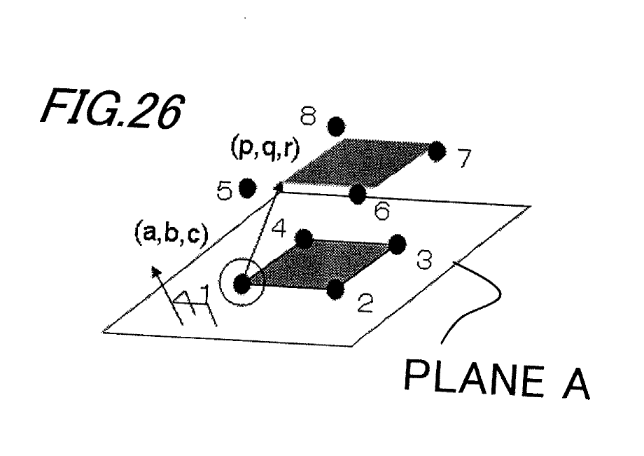

FIG. 24 is a flowchart illustrating the process in F34 of FIG. 18A, i.e., the parallelepiped generating process. FIG. 25 illustrates the parallelogram before forming the parallelepiped, i.e., the parallelogram before being moved. FIG. 26 illustrates the parallelograms before forming the parallelepiped, i.e., the parallelograms before and after being moved.

To begin with, the information processing device determines translation vectors (p, q, r) when moving the generated parallelograms in parallel (F340). For generating the translation vectors, the information processing device newly prepares a coordinate system so that the direction of the normal vector on the plane A containing the parallelogram becomes a z-axis direction (F341).

Then, the translation vectors (p, q, r) are set within the ranges of the following formulae 7, 8 and 9 (F342). Now, the four vertexes of the parallelogram are given such as (xi, yi, zi) (i=1 through 4). Further, the remaining four vertexes of the microregion are given such as (xi, yi, zi) (i=5 through 8).

When MIN(x5,x6,x7,x8)−MIN(x1,x2,x3,x4)<MAX(x5,x6,x7,x8)−MAX(x1,x2,x3,x4),MIN(x5,x6,x7,x8)−MIN(x1,x2,x3,x4)<p<MAX(x5,x6,x7,x8)−MAX(x1,x2,x3,x4);

When MAX(x5,x6,x7,x8)−MAX(x1,x2,x3,x4)<MIN(x5,x6,x7,x8)−MIN(x1,x2,x3,x4),MAX(x5,x6,x7,x8)−MAX(x1,x2,x3,x4)<p<MIN(x5,x6,x7,x8)−MIN(x1,x2,x3,x4); (Formula 7)

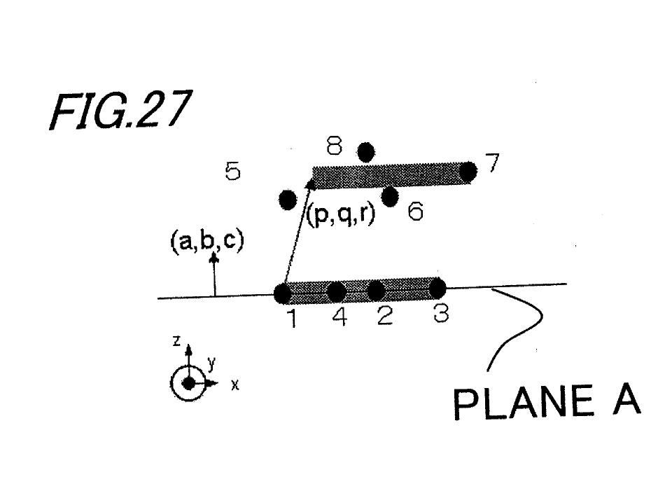

FIG. 27 illustrates a relation expressed in the formula 7. The information processing device calculates, when moving the parallelogram from the plane A, a variation quantity Δ1 on the side of the minimum value in the coordinates and a variation quantity Δ2 on the side of the maximum value between x-coordinates “x1, x2, x3, x4” of the parallelogram before being moved and x-coordinates “x5, x6, x7, x8” of the parallelogram after being moved as x-components p of the translation vectors of the movements.

Δ1=MIN(x5,x6,x7,x8)−MIN(x1,x2,x3,x4);

Δ2=MAX(x5,x6,x7,x8)−MAX(x1,x2,x3,x4);

Then, the information processing device varies the x-components p within the ranges set with the variation quantities Δ1 and Δ2. The calculation of y-components q of the translation vectors is conducted in the same way as the x-components are done. The variation pitch may be set to a value designated by the user.

When MIN(y5,y6,y7,y8)-MIN(y1,y2,y3,y4)<MAX(y5,y6,y7,y8)−MAX(y1,y2,y3,y4),MIN(y5,y6,y7,y8)−MIN(y1,y2,y3,y4)<q<MAX(y5,y6,y7,y8)−MAX(y1,y2,y3,y4);

When MAX(y5,y6,y7,y8)−MAX(y1,y2,y3,y4)<MIN(y5,y6,y7,y8)−MIN(y1,y2,y3,y4),MAX(y5,y6,y7,y8)−MAX(y1,y2,y3,y4)<q<MIN(y5,y6,y7,y8)−MIN(y1,y2,y3,y4); (Formula 8)

Further, z-components of the translational vectors are varied in the range between the minimum value and the maximum value of the remaining four vertexes of the microregion. The variation pitch may be set to a value designated by the user.

MIN(z5,z6,z7,z8)−z1<r<MAX(z5,z6,z7,z8)−z1 (Formula 9)

Then, the information processing device moves the parallelograms in parallel according to the translational vectors (p, q, r) to configure the parallelepiped (F343). Subsequently, the information processing device displaces the atoms 5, 6, 7, 8 in the way of being overlapped with the vertexes of the parallelograms moved in parallel. The operations described above are performed for the respective translational vectors, and the translational vectors (p, q, r) having the smallest RMS of the displacement quantity are adopted (F344). Then, the information processing device generates the parallelepiped according to the adopted translational vectors (p, q, r).

<Calculation of Stress Distribution>

The information processing device periodically arrays the parallelepipeds acquired in the process in F3 of FIG. 1, and obtains the mean value of the stresses by the technique based on the quantum theory using the empirical parameters with respect to the virtual crystals that are periodically arranged. The mean stress is obtained according to the mathematical expression 9. Details of the process of calculating the mean value of the stresses according to the mathematical expression 9 are given as follows.

Generally, the stress can be obtained as by the mathematical expression 10 in a manner that differentiates the total energy with distortion quantities εαβ.

$$\begin{matrix}{T}_{αβ} = - \frac{\partial {E}_{tot}}{\partial {ɛ}_{αβ}} \\ = - {\sum }_{i} 〈 Ψ \vert \frac{{\hat{p}}_{i α} {\hat{p}}_{i β}}{{m}_{i}} - {r}_{i β} {∇}_{i α} ( V ) \vert Ψ 〉\end{matrix} \qquad [ Mathematical Expression 10 ]$$

In the case of using the tight-binding method, the total energy can be expressed by the mathematical expression 1, and the stress is therefore given as below.

$${T}_{αβ} = \frac{\partial {E}_{bs}}{\partial {ɛ}_{αβ}} + \frac{\partial {E}_{rep}}{\partial {ɛ}_{αβ}} \\ \begin{matrix}\frac{\partial {E}_{bs}}{\partial {ɛ}_{αβ}} = 2 \frac{\partial }{\partial {ɛ}_{αβ}} {\sum }_{n} {ɛ}_{n} \\ = 2 \frac{\partial }{\partial {ɛ}_{αβ}} {\sum }_{n} 〈 {ϕ}_{n} \vert HTB \vert {ϕ}_{n} 〉 \\ = 2 \frac{\partial }{\partial {ɛ}_{αβ}} {\sum }_{n} {\sum }_{ij} {c}_{i} {c}_{j}^{*} {\sum }_{{l}_{0} , l} {e}^{i k \cdot ( {R}_{l} - {R}_{{l}_{0}} )} \\ \int d r {φ}_{j}^{*} ( r - {τ}_{j} - {R}_{{l}_{0}} ) {H}_{TB} {φ}_{i} ( r - {τ}_{i} - {R}_{l} )\end{matrix} \qquad [ Mathematical Expression 11 ]$$

Herein, when using the mathematical expression 5;

$$[ Mathematical Expression 12 ]$$

$$\begin{matrix}\frac{\partial {E}_{bs}}{\partial {ɛ}_{αβ}} = 2 \frac{\partial }{\partial {ɛ}_{αβ}} {\sum }_{n} {\sum }_{ij} {c}_{i} {c}_{j}^{*} {\sum }_{{l}_{0} , l} H ( {τ}_{i} , {τ}_{j} , {R}_{l} , {R}_{{l}_{0}} ) \\ = 2 {\sum }_{n} {\sum }_{ij} {c}_{i} {c}_{j}^{*} {\sum }_{{l}_{0} , l} \frac{\partial }{\partial {ɛ}_{αβ}} H ( {τ}_{i} , {τ}_{j} , {R}_{l} , {R}_{{l}_{0}} )\end{matrix}$$

Given now is a case where Sij in the mathematical expression 5 is a unit matrix. R can be expressed in a distorted state as below.

$${R}_{α} = {R}_{α} + {\sum }_{β} {ɛ}_{αβ} {R}_{β} \qquad [ Mathematical Expression 13 ]$$

Accordingly;

$$[ Mathematical Expression 14 ]$$

$$\begin{matrix}\frac{\partial {E}_{bs}}{\partial {ɛ}_{αβ}} = 2 \frac{\partial }{\partial {ɛ}_{αβ}} {\sum }_{n} {\sum }_{ij} {c}_{i} {c}_{j}^{*} {\sum }_{{l}_{0} , l} \frac{\partial }{\partial {R}_{α}} H ( {τ}_{i} , {τ}_{j} , {R}_{l} , {R}_{{l}_{0}} ) \frac{\partial {R}_{α}}{\partial {ɛ}_{αβ}} \\ = 2 {\sum }_{n} {\sum }_{ij} {c}_{i} {c}_{j}^{*} {\sum }_{{l}_{0} , l} \frac{\partial }{\partial {R}_{α}} H ( {τ}_{i} , {τ}_{j} , {R}_{l} , {R}_{{l}_{0}} ) {R}_{β}\end{matrix}$$

On the other hand;

$$\frac{\partial {E}_{rep}}{\partial {ɛ}_{αβ}} = \frac{\partial {E}_{rep}}{\partial {R}_{α}} \frac{\partial {R}_{α}}{\partial {ɛ}_{αβ}} = \frac{\partial {E}_{rep}}{\partial {R}_{α}} {R}_{β} \qquad [ Mathematical Expression 15 ]$$

Furthermore, the information processing device replaces the microregions of the substance with the parallelepiped and assumes a structure in which the parallelepiped is iterated infinitely in the X- Y- and Z-directions. In the structure where the parallelepiped is iterated infinitely in the X- Y- and Z-directions, the substance can be assumed to be uniform, and hence a notation < > representing the average can be simply transformed into an integration symbol within the single parallelepiped. Such being the case, the mathematical expression 10 is a formula for averaging the stresses in the parallelepiped with a wave function Ψ.

In the mathematical expression 10, a first term in the stresses to be averaged with the wave function Ψ, i.e., the first term indicated by a product of operators of a momentum is an expression in which kinetic energy of the atoms is differentiated once. The first term is a term of a pressure produced from the kinetic energy of the atoms. Further, a second term in the stresses to be averaged with the wave function Ψ is a term of the pressure produced by a potential, e.g., a Coulomb force etc.

Then, the stress given in terms of assuming the periodic structure by use of the translational vector R can be obtained by adopting the periodic structure of the parallelepiped. Moreover, the wave function W can be, as expressed in the mathematical expression 3, set as a sum of atomic orbitals, and coefficients of the mathematical expression 3 can be solved by models of the mathematical expressions 4 and 5. Further, the mathematical expression 5 may be set so as to be coincident with the value of the real substance by employing the empirical parameters. Accordingly, the mathematical expression 9 enables the mean value of the stresses of the parallelepiped to be obtained.

As discussed above, the microregions are replaced with the parallelepiped, and the structure of infinitely iterating the parallelepiped is assumed, whereby the formula for averaging the stresses in the mathematical expression 9 or 10 can result in the integration within the parallelepipeds.

As described above, the mean value of the stresses can be eventually expressed by the models of the mathematical expressions 14 and 15 and can be therefore calculated by use of Ci, Cj defined as solutions of a problem of eigenvalue in a way that differentiates Hij and Eprep with R.

Then, the mean stress within the parallelepiped, which is obtained by the formula, i.e., the mathematical expression 9, is set as the stress of the microregions of the substance. The microregions may be stored in a file of a storage device in a model such as (Xi, Yi, Zi, Txxi, Txyi=Tyzi, Txzi=Tzxi, Tyyi, Tyzi=Tzyi, Tzzi) in the way of being associated with the central coordinates, e.g., centers of gravities (Xi, Yi, Zi) of the microregions. Accordingly, the processes in F3 and F4 illustrated in FIG. 1 are repeated by the number of microregions, thereby enabling the stresses in the respective microregions within the substance to be calculated and stored in the file.

In the process in F6 of FIG. 1, the local stress is obtained by linearly interpolating the stress obtained in each region. The stress values calculated in the respective microregions are set as values of the coordinates of the centers of gravities of the eight atoms building up the parallelepiped. Then, the functions of the stresses (the stress distribution) in the entire space are obtained by performing the linear interpolations.

For example, an assumption is that in the microregion V1, the center of gravity is given by (X1, Y1, Z1), and a stress Tyzi in the X-axis direction is obtained. Further, another assumption is that the center of gravity of the microregion V2 adjacent to the microregion V1 is given by (X1+D, Y1, Z1), and a stress Tyz2 in the X-axis direction is obtained.

In this case, a stress Tyz(d) in the X-axis direction between (X1, Y1, Z1) and (X1+D, Y1, Z1) may be given such as: Tyz(d)=((D−d)Tyz1+dTyz2)/D, where d is a distance from the center of gravity of the microregion V1.

As discussed above, the information processing device, in the calculation technique based on the quantum theory using the empirical parameters, enables the calculation of the local stress and the calculation of the distribution of the calculates stresses. It is therefore feasible to expand the range of the physical quantities, which can be obtained.

Namely, the information processing device divides the atomic structure of the substance into the microregions on the basis of the crystalline structure of the atom contained in the substance. Then, the information processing device replaces the microregions acquired by the division with the parallelepiped, and generates the virtual crystalline structure based on the iteration of the parallelepiped. The virtual crystalline structure may be considered as the uniform substance, and hence the information processing device obtains the mean value of the stresses by the integrating calculation within one single parallelepiped in the virtual crystalline structure. Then, the information processing device sets the mean value of the stresses obtained in the virtual crystalline structure as the stress of the microregions. With the repetition of the processes described above, the information processing device calculates the stress of each micro portion of the atomic structure of the substance. Accordingly, the information processing device can obtain the stress distribution, i.e., the local stresses in the substance.

In the procedure described above, the information processing device divides the substance into the micro portions on the basis of the crystalline structure of the atom contained in the substance, and can therefore generate the virtual crystalline structure in the state where the relation between the micro portion and the atomic structure ambient to the micro portion is made similar to the intrinsic atomic structure to the greatest possible degree. Accordingly, the mean stress obtained from the virtual crystalline structure may be considered approximate to the stress acting on the micro portion in the substance. The information processing device is enabled to calculate the mean stress based on the virtual crystalline structure in the state of keeping the physical properties intrinsic to the substance as described above to the greatest possible degree.

Then, the information processing device employs the quantum theory using the empirical parameters that are comparatively small of the calculation load and can therefore calculate the local stresses important for understanding the occurrence of defects and cracks in the substance at the atomic level in developing the nanodevices about a practical scale of system including several thousands of atoms or more in a practical length of time.

Further, the following there characteristic points are provided.

(1) The calculation described above is performed independently on the per microregion basis and hence facilitates the speed-up of the parallel calculation by the processor. (2) In the calculation of the local stress according to the present invention, such a characteristic is provided that the substance undergoing the simulation is decomposed into the microregions, and therefore, if the atomic coordinates are given and even when using the calculation technique based on the quantum theory not employing the empirical parameters having a heavy calculation load, the stress of the microregion can be calculated. That is to say, there is no limit to the simulation for obtaining the atomic structure or the atomic position of the substance, which is the premise for the stress calculation. For instance, the information processing device is capable of calculating the stress with respect to the atomic structure based on processes other than the processes in FIG. 2. (3) It is feasible to calculate the local stresses only for required regions, and a calculation cost can be reduced corresponding to the requirements.

### Second Working Example

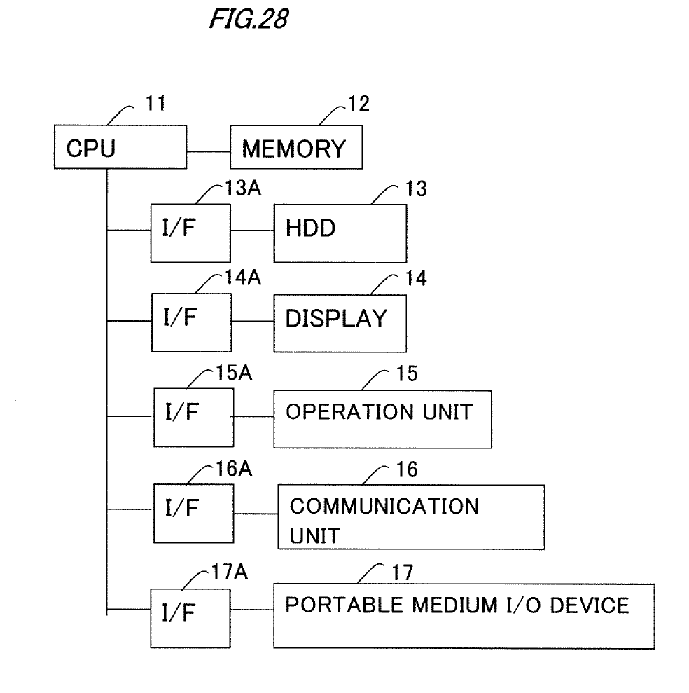

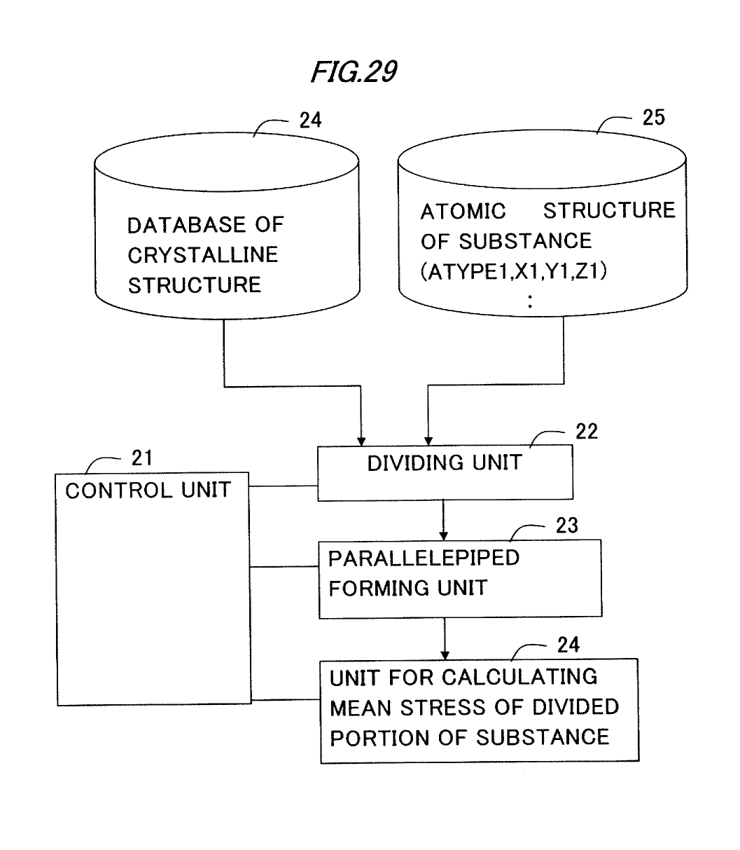

The information processing device according to a second working example will be described with reference to FIGS. 28 and 29. FIG. 28 illustrates a hardware configuration of the information processing device according to the second working example. The information processing device is a computer connectable to a network 30. The information processing device includes a CPU 11, a memory 12, an external storage device such as a hard disk drive 13, a display 14, an operation unit 15, a communication unit 16 and a portable storage medium input/output device 17.

The CPU 11 executes the computer program deployed in the executable manner on the memory 12, thereby providing the functions of the information processing device. The CPU 11 may be a CPU including, without being limited to a single core, multi cores.

The memory 12 is stored with the computer program executed by the CPU 11 and the data etc processed by the CPU 11. The memory 12 includes a nonvolatile ROM (Read Only Memory) and a volatile DRAM (Dynamic Random Access Memory).

A hard disk driven by the hard disk drive 13 is stored with the computer program deployed on the memory 12 or the data etc processed by the CPU 11. An SSD (Solid State Drive) such as a flash memory may be employed as a substitute for the hard disk drive 13. The external storage device such as the hard disk drive 13 or the SSD etc is connected via an interface 13A to the CPU 11.

The interface 13A is an interface such as a USB (Universal Serial Bus), an IDE (Integrated Drive Electronics), an SCSI (Small Computer System Interface) and an FC (Fibre Channel).

The display 14 is, e.g., a liquid crystal display, an electroluminescence panel, etc. The display 14 is connected via the interface 13A to the CPU 11. The interface 13A is an interface such as a graphic module like a VGA (Video Graphics Array) and a DVI (Digital Visual Interface).

The operation unit 15 is an input device such as a keyboard, a mouse, a touch panel and an electrostatic pad. The electrostatic pad is a device used for detecting a user's operation such as tracing a flat pad with a finger etc and controlling a position and a moving state of a cursor on the display in response to the user's operation. For example, a finger motion of the user is detected from a change in electrostatic capacity of an electrode under the flat pad. The operation unit 15 is connected via an interface 15A to the CPU 11. The interface 15A is an interface of, e.g., the USB.

The communication unit 16 is also called a NIC (Network Interface Card). The communication unit 16 is an interface of, e.g., a LAN (Local Area Network). The communication unit 16 is connected via an interface 16A to the CPU 11. The interface 16A is, e.g., an expansion slot connected to an internal bus of the CPU 11.

The portable storage device 17 is an input/output device such as a CD (Compact Disc), a DVD (Digital Versatile Disk), a Blu-ray disc and a flash memory card. The portable storage device 17 is connected via an interface 17A to the CPU 11. The interface 17A is an interface such as the USB and the SCSI.

Note that the sole computer is exemplified as the information processing device in FIG. 28. The information processing device may, however, be a plurality of computers that is linked up with each other and executes the processes by sharing.

FIG. 29 illustrates a functional configuration of the information processing device according to the second working example. The information processing device includes a database 24 of the crystalline structures and an atomic structure file 25 of the substance on the external storage device such as the hard disk. The database 24 of the crystalline structures corresponds to a unit to store an atomic structure containing atomic positions in the crystal. The atomic structure file 25 of the substance corresponds to a unit to store an atomic structure containing atomic positions in a substance.

At least any one of the database 24 of the crystalline structures and the atomic structure file 25 of the substance may, however, be a device, e.g., the memory 12 other than the external storage device of the information processing device. Further, at least any one of the database 24 of the crystalline structures and the atomic structure file 25 of the substance may exist in a storage unit on the network, e.g., SAN (Storage Area Network). Still further, at least any one of the database 24 of the crystalline structures and the atomic structure file 25 of the substance may exist on another computer, e.g., a database server on an accessible network via the network.

A format of the database 24 of the crystalline structures is similar to the format depicted in FIG. 15 in the first working example. Moreover, the atomic structure file 25 of the substance is obtained by the atomic structure optimization process, such as the method of steepest descent and the conjugate gradient method, which uses the empirical parameters explained in the first working example. Herein, the atomic structure file 25 of the substance includes a multiplicity of records containing, e.g., the atomic type (ATYPEi) and the X-coordinates (Xi), the Y-coordinates (Yi) and the Z-coordinates (Zi) of the atoms.

Then, the information processing device, with the CPU 11 executing the program deployed in the executable manner on the memory 12, functions as a control unit 21, a dividing unit 22, a parallelepiped forming unit 23 and a mean stress calculating unit 24 of the divided portions of the substance.

To be specific, the diving unit 22 reads the positions of the atoms contained in the atomic structure of the substance from the atomic structure file 25 of the substance. Then, the diving unit 22 compares the atomic positions in the divided portions into which the substance is divided with the atomic positions in the crystal containing the atoms. Subsequently, the diving unit 22 compares the atomic positions in the divided portions into which the substance is divided with the atomic positions of the crystal containing the atoms of the substance, and maps the atomic positions of the divided portions to the atomic positions in the crystal so as to minimize an evaluation value of a relative distance between the atoms corresponding to each other between the divided portions and the crystal. Such a procedure of mapping the atoms of the divided portions to the atoms in the crystalline structure is similar to the processes illustrated in FIG. 8 in the first working example. Then, the diving unit 22 specifies the divided portion of the substance, which corresponds to the unit lattice of the crystal. Herein, the divided portion corresponds to, e.g., what is called the microregion of the substance in the first working example.

The parallelepiped forming unit 23 acquires the divided portion of the substance divided by the diving unit 22. The divided portion is, e.g., the hexahedron. The parallelepiped forming unit 23 determines such a parallelepiped as to minimize the evaluation value of the relative distance between the vertex of the divided portion and the vertex of the parallelepiped. In this case, the processing procedure of the parallelepiped forming unit 23 is similar to the processes in FIGS. 18A-24 illustrated in FIG. in the first working example.

The mean stress calculating unit 24 generates the virtual crystalline structure in which the parallelepiped generated by the parallelepiped forming unit 23 is iterated. Then, the mean stress calculating unit 24 calculates the means stress of the virtual crystalline structure according to the same calculation formula as the formula 10 given in the first working example.

The control unit 21 processes the atomic structure file 25 of the substance by use of the diving unit 22, the parallelepiped forming unit 23 and the mean stress calculating unit 24. To be specific, the atomic structure given in the atomic structure file 25 of the substance is divided into the divided portions, the divided portions are transformed into the parallelepiped to generate the virtual crystalline structure, and the mean stress acquired from the virtual crystalline structure is set as the stress of the divided portion. The control unit 21 generates the stress distribution of the stresses caused in the atomic structures given in the atomic structure file 25 of the substance by the repetitive executions of the diving unit 22, the parallelepiped forming unit 23 and the mean stress calculating unit 24. The stress distribution can be expressed such as (Xi, Yi, Zi Yxyi, Tyzi, Tzxi) by use of the centers of gravities (Xi, Yi, Zi) of the divided portions and stored in the memory 12.

Note that the mean stress acquired by the mean stress calculating unit 24 is the stress acting on between the divided portions divided by the diving unit 22, i.e., the stress acting on the boundary surface between the divided portion and another divided portion. On the other hand, the control unit 21 obtains the stress in the position other than the boundary surface between the divided portion and another divided portion by the linear interpolation based on the distance from the boundary surface. Thus, the control unit 21 outputs the stress distribution in the substance, which is given in the atomic structure file 25 of the substance. In FIG. 29, though omitted, destinations to which the stress distribution is output are, e.g., a file in the external storage device, the display 14A, a field of variables of another application program in the memory 12, etc.

### <<Computer-Readable Recording Medium>>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disk, a magneto-optic disk, a CD-ROM, a CD-R/W, a DVD, a Blu-ray disc, a DAT, an 8 mm tape, a memory card such as a flash memory, etc are given as those removable from the computer. Further, a hard disk, a ROM (Read-Only Memory), etc are given as the recording mediums fixed within the computer etc.

### INDUSTRIAL APPLICABILITY

The occurrence of the defects an cracks in the substance can be clarified at the atomic level in the development of the new materials and new devices by use of the technology described in the embodiment. Therefore, the stability in terms of the atomic structure of the purpose-suited device can be predicted to some extent by performing the simulation before being actually manufactured on an experimental basis. This leads to reductions in development time and cost and a decrease in environmental load due to the development. The technology described in the embodiment can be applied to the technical field of the developments of the new materials and the devices and to the field of the information processing technology for supporting the developments of the new materials and the devices.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An simulation device comprising:
a first memory that stores an atomic structure containing atomic positions in a substance including an atom;
a second memory that stores an atomic structure containing an atomic positions in a crystal containing the atom;
a dividing unit that compares the atomic positions of a plurality of divided portions into which the substance is divided with the atomic positions in the crystal, maps the atomic positions of the divided portions to the atomic positions of the crystal to minimize an evaluation value of a relative distance between each atom of the divided portions and each atom of the crystal corresponding to each other and to specify the divided portions of the substance corresponding to a unit lattice of the crystal;
a parallelepiped forming unit that determines a parallelepiped to minimize an evaluation value of the relative distance between a vertex of the divided portion and a vertex of the parallelepiped;
a mean stress calculating unit that calculates a mean stress applied to the parallelepiped in a virtual crystalline structure in which the parallelepiped is iterated; and
a control unit that specifies stresses of the respective divided portions of the substance by controlling the dividing unit, the parallelepiped forming unit and the mean stress calculating unit repeatedly.

2. An simulating method comprising:
comparing an atomic positions of a plurality of divided portions into which the substance is divided with the atomic positions in a crystal containing the atoms of the substance;
mapping the atomic positions of the divided portions to the atomic positions of the crystal to minimize an evaluation value of a relative distance between each atom of the divided portions and each atom of the crystal corresponding to each other to specify the divided portions of the substance corresponding to a unit lattice of the crystal;
determining a parallelepiped to minimize an evaluation value of the relative distance between a vertex of the divided portion and a vertex of the parallelepiped;
calculating a mean stress applied to the parallelepiped in a virtual crystalline structure in which the parallelepiped is iterated; and
specifying stresses of the respective divided portions of the substance by repeatedly executing the comparing, the mapping, the determining and the calculating.

3. A non-transitory computer readable medium storing a program including a process for directing a computer to perform a process, the process comprising:
comparing an atomic positions of a plurality of divided portions into which the substance is divided with the atomic positions in a crystal containing the atoms of the substance,
mapping the atomic positions of the divided portions to the atomic positions of the crystal to minimize an evaluation value of a relative distance between each atom of the divided portions and each atom of the crystal corresponding to each other to specify the divided portions of the substance corresponding to a unit lattice of the crystal;
determining a parallelepiped to minimize an evaluation value of the relative distance between a vertex of the divided portion and a vertex of the parallelepiped;
calculating a mean stress applied to the parallelepiped in a virtual crystalline structure in which the parallelepiped is iterated; and
specifying stresses of the respective divided portions of the substance by repeatedly executing the dividing, the mapping, the determining and the calculating.
